(19) United States
(12) Patent Application Publication
(10) Pub. No.: US 2026/0253605 A1
(43) Pub. Date: Aug. 27, 2026

(54) SYSTEM

(71) Applicant: SoftBank Group Corp., Tokyo (JP)

(72) Inventor: Shu ANZAI, Tokyo (JP)

(73) Assignee: SoftBank Group Corp., Tokyo (JP)

(21) Appl. No.: 19/534,797

(22) Filed: Feb. 10, 2026

(30) Foreign Application Priority Data
Feb. 21, 2025 (JP) 2025-026991

(51) Int. Cl. G10L 25/63; G06F 40/284; G06V 10/82; G10L 25/30

(52) U.S. Cl. CPC G10L 25/63; G06F 40/284; G06V 10/82; G10L 25/30

(57) ABSTRACT

The system according to the embodiment comprises a collection unit, a prompt generation unit, a generation unit, and a provision unit. The collection unit collects information acquired from a vehicle. The prompt generation unit converts the information collected by the collection unit into prompts. The generation unit generates a response based on the information converted into prompts by the prompt generation unit. The provision unit provides the response generated by the generation unit to the driver.

### CROSS-REFERENCE TO RELATED APPLICATION

The present application claims priority to and incorporates by reference the entire contents of Japanese Patent Application No. 2025-026991 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, information acquired from a vehicle has not been sufficiently provided to the driver in real time, and there is room for improvement.

### SUMMARY OF THE INVENTION

The system according to the embodiment comprises a collection unit, a prompt generation unit, a generation unit, and a provision unit. The collection unit collects information acquired from a vehicle. The prompt generation unit converts the information collected by the collection unit into prompts. The generation unit generates a response based on the information converted into prompts by the prompt generation unit. The provision unit provides the response generated by the generation unit to the driver.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

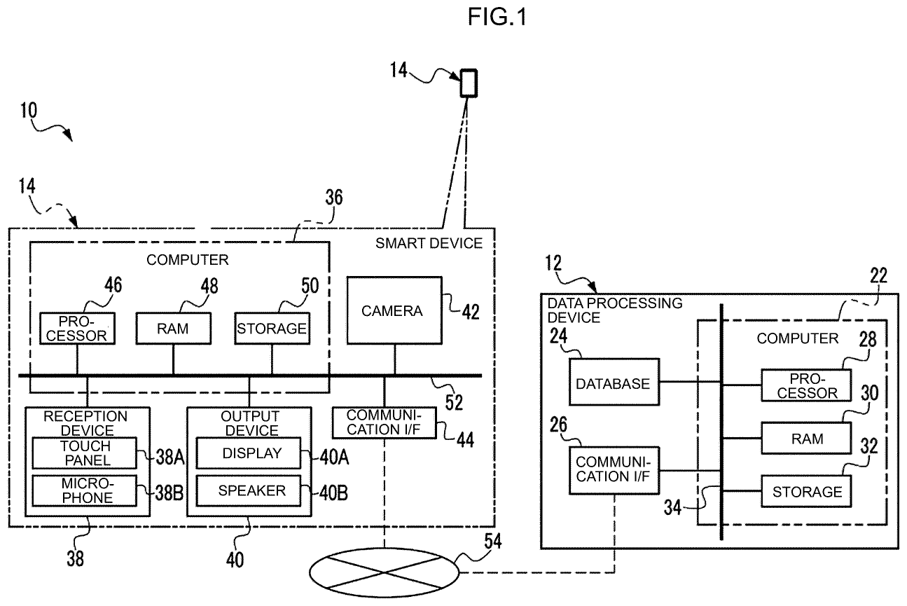

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

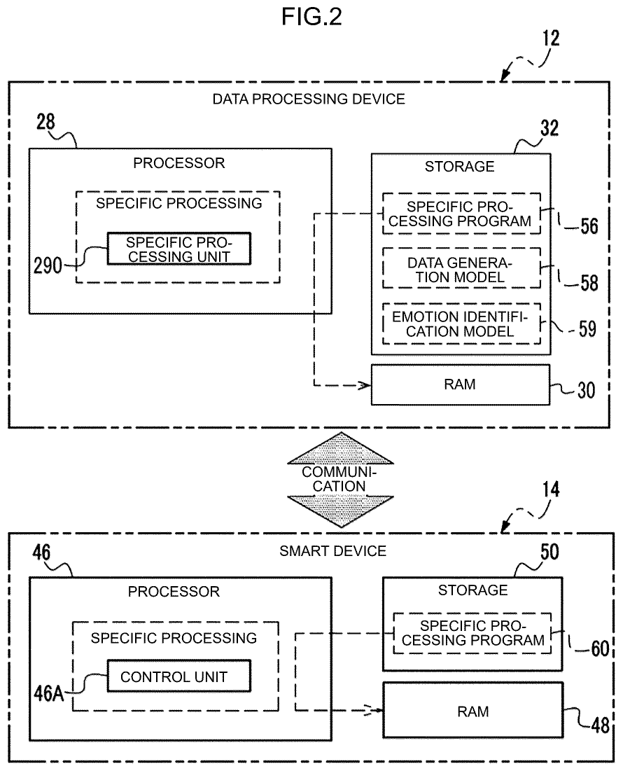

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The system according to the embodiment of the present invention aims for further evolution of generative AI and proposes a system as a new approach to access not only web information but also local, real-time, and accurate information, by providing a plugin function that accesses a wide range of information required by a driver while driving through connection with a connected car. This system converts structured information acquired from the vehicle into prompts and inputs them to the generative AI. Next, the generative AI generates a response based on the prompt and provides it to the driver. This mechanism contributes to improving the user experience (UX) of personal assistant services. For example, the information acquired from the vehicle includes position information, speed, remaining fuel amount, engine status, surrounding traffic conditions, weather information, and so on. These pieces of information are acquired in real time through vehicle sensors and communication functions. For example, position information is acquired using GPS, while speed and remaining fuel amount are acquired from internal vehicle sensors. Engine status, surrounding traffic conditions, and weather information can be acquired via the vehicle's communication functions. Next, the acquired information is converted into prompts. Prompt generation refers to converting the acquired information into a format that is easily understood by the generative AI. For example, position information is converted into a format such as “The current position is XX”, and speed and remaining fuel amount are converted into formats such as “The current speed is XX km/h” and “The remaining fuel amount is XX liters”. This enables the generative AI to generate appropriate responses based on the acquired information. The generated response is provided to the driver. For example, if the driver asks “Where is the nearest gas station?”, the generative AI proposes the optimal gas station based on the vehicle's position information and remaining fuel amount. If the driver asks “Should I turn right at the next intersection?”, the generative AI provides appropriate advice based on surrounding traffic conditions and weather information. In this way, the generative AI provides real-time and accurate information to the driver and supports driving. This mechanism improves the UX of personal assistant services. Since the driver can obtain necessary information in real time while driving, driving efficiency and safety are improved. Furthermore, the information provided by the generative AI is accurate and highly reliable, allowing the driver to drive with peace of mind. Additionally, since the generative AI generates appropriate responses to the driver's questions, the driver can continue driving without stress. As a result, the generative AI system can provide real-time and accurate information to the driver. Specifically, this system collects multidimensional structured data (e.g., position coordinates (latitude/longitude), speed values (km/h), remaining fuel amount (liters), engine temperature (° C.), OBD-II codes, traffic flow data, weather codes from weather APIs, etc.) obtained from various vehicle sensors (GPS receiver, speed sensor, fuel sensor, engine diagnostic module, external communication module, etc.) as time-series tensors or structured data in JSON format. When converting these data into natural language text in the prompt generation unit, the system automatically formats them into specific sentences such as “The current position is 35.6895,139.6917”, “The current speed is 60 km/h”, “The remaining fuel amount is 12 liters”, “The engine temperature is 90° C.”, “The surrounding traffic condition is congestion”, “The weather is rainy”. The prompt generation unit applies completion algorithms or outlier removal filters when missing data or abnormal values are detected, ensuring the quality of input to the generative AI. As the generative AI, for example, a large-scale language model (with billions of parameters, Transformer architecture) is used, tokenizing the input prompt and performing sequence transformation in encoder-decoder layers. Examples of input include “The current position is 35.6895,139.6917. The remaining fuel amount is 12 liters. Please tell me the nearest gas station.” or “The current speed is 60 km/h. Should I turn right at the next intersection?”. The generative AI generates natural language text as output (e.g., “The nearest gas station is at point A, 2 km ahead”, “Right turn is not recommended. There is congestion near the intersection.”) and can also attach options with scores or confidence labels (e.g., confidence 0.92). In subsequent processing, the output of the generative AI is sent to a threshold determination unit, and only when the confidence exceeds a certain value is it sent to the speech synthesis module or in-vehicle display. As a technical effect, this system, unlike conventional human information search or simple rule-based responses, integrates multiple real-time sensor data and performs sequence analysis and semantic understanding in high-dimensional space, greatly improving the accuracy and immediacy of responses. This dramatically enhances the safety and convenience of driving support systems, reduces driver burden, and contributes to accident prevention. Application fields include personal assistants for general passenger cars, operation management for commercial vehicles, navigation support for emergency vehicles, and driving assistance for disabled persons. Furthermore, it can be applied to cloud-linked fleet management and realization of smart cities through collaboration with urban traffic infrastructure.

The generative AI system according to the embodiment comprises a collection unit, a prompt generation unit, a generation unit, and a provision unit. The collection unit collects information acquired from the vehicle. The information acquired from the vehicle includes, for example, position information, speed, remaining fuel amount, engine status, surrounding traffic conditions, and weather information, but is not limited thereto. The collection unit, for example, acquires position information of the vehicle using GPS. The collection unit can also acquire speed and remaining fuel amount using internal vehicle sensors. Furthermore, the collection unit can acquire engine status, surrounding traffic conditions, and weather information using the vehicle's communication functions. For example, the collection unit acquires position information using GPS, and speed and remaining fuel amount from internal vehicle sensors. Engine status, surrounding traffic conditions, and weather information can be acquired via the vehicle's communication functions. The prompt generation unit converts the information collected by the collection unit into prompts. Prompt generation refers to converting the collected information into a format that is easily understood by the generative AI. For example, the prompt generation unit converts position information into a format such as “The current position is XX”. The prompt generation unit can also convert speed and remaining fuel amount into formats such as “The current speed is XX km/h” and “The remaining fuel amount is XX liters”. For example, the prompt generation unit converts position information into a format such as “The current position is XX”, and speed and remaining fuel amount into formats such as “The current speed is XX km/h” and “The remaining fuel amount is XX liters”. The generation unit generates a response based on the information converted into prompts by the prompt generation unit. For example, the generation unit generates an appropriate response to a driver's question based on the information converted into prompts. For example, if the driver asks “Where is the nearest gas station?”, the generation unit proposes the optimal gas station based on the vehicle's position information and remaining fuel amount. If the driver asks “Should I turn right at the next intersection?”, the generation unit provides appropriate advice based on surrounding traffic conditions and weather information. For example, the generation unit generates an appropriate response to a driver's question based on the information converted into prompts. The provision unit provides the response generated by the generation unit to the driver. For example, the provision unit provides the generated response to the driver via voice or display. The provision unit can provide the generated response by voice or display. For example, the provision unit provides the generated response to the driver via voice or display. This enables the generative AI system according to the embodiment to provide real-time and accurate information to the driver. Specifically, the generative AI system collects multidimensional structured data (e.g., position coordinates (latitude/longitude), speed values (km/h), remaining fuel amount (liters), engine temperature (° C.), OBD-II codes, traffic flow data, weather codes from weather APIs, etc.) obtained from various vehicle sensors (GPS receiver, speed sensor, fuel sensor, engine diagnostic module, external communication module, etc.) as time-series tensors or structured data in JSON format. The collection unit acquires these data every second or upon event triggers, and applies statistical completion algorithms (e.g., linear interpolation, median completion) or outlier removal filters (e.g., Z-score determination) to ensure data quality in case of missing or abnormal values. The prompt generation unit uses template-based sentence generation engines or rule-based mapping tables to automatically convert the collected structured data into natural language text. For example, position information (latitude 35.6895, longitude 139.6917) is converted into “The current position is 35.6895,139.6917”, speed 60 into “The current speed is 60 km/h”, and remaining fuel amount 12 into “The remaining fuel amount is 12 liters”. The prompt generation unit selects different templates and levels of detail for each information category (e.g., navigation, vehicle status, weather, traffic), and automatically adjusts sentence length and expression according to importance and driver status (e.g., estimated stress value). The generation unit inputs the natural language text received from the prompt generation unit into a large-scale language model with billions of parameters and a Transformer architecture. Examples of input include “The current position is 35.6895,139.6917. The remaining fuel amount is 12 liters. Please tell me the nearest gas station.” or “The current speed is 60 km/h. Should I turn right at the next intersection?”. The generation unit tokenizes the input text, performs sequence transformation in encoder-decoder layers, and generates natural language text as output (e.g., “The nearest gas station is at point A, 2 km ahead”, “Right turn is not recommended. There is congestion at the intersection.”). The generation unit attaches confidence scores (e.g., 0.92) and option labels to the output, and only sends the output to the provision unit if the confidence exceeds a certain threshold in the subsequent threshold determination unit. The provision unit provides information to the driver via a speech synthesis module (e.g., WaveNet-based TTS) or in-vehicle display control module. Examples of voice output include “There is a gas station at point A, 2 km ahead”, and examples of display output include “Right turn is not recommended. There is congestion.” As a technical effect, this system, unlike conventional human information search or simple rule-based responses, integrates multiple real-time sensor data and performs sequence analysis and semantic understanding in high-dimensional space, greatly improving the accuracy and immediacy of responses. This dramatically enhances the safety and convenience of driving support systems, reduces driver burden, and contributes to accident prevention. Application fields include personal assistants for general passenger cars, operation management for commercial vehicles, navigation support for emergency vehicles, and driving assistance for disabled persons. Furthermore, it can be applied to cloud-linked fleet management and realization of smart cities through collaboration with urban traffic infrastructure.

The collection unit can collect position information of the vehicle, speed, remaining fuel amount, engine status, surrounding traffic conditions, and weather information. For example, the collection unit acquires position information of the vehicle using GPS. For example, the collection unit can acquire position information of the vehicle using a high-precision GPS system. The collection unit can also acquire speed and remaining fuel amount using internal vehicle sensors. For example, the collection unit acquires the vehicle's speed using internal sensors and the remaining fuel amount using a fuel tank sensor. Furthermore, the collection unit can acquire engine status, surrounding traffic conditions, and weather information using the vehicle's communication functions. For example, the collection unit acquires engine status using communication functions and acquires surrounding traffic conditions and weather information in real time. Thus, by collecting diverse information from the vehicle, the collection unit can provide necessary information to the driver. Specifically, the collection unit acquires multidimensional sensor data such as speed (km/h), remaining fuel amount (liters), engine RPM (rpm), engine temperature (° C.), battery voltage (V), etc., at one-second intervals or upon event triggers via the vehicle's CAN bus or OBD-II interface. Position information is acquired as latitude, longitude, altitude, and velocity vector from a GNSS (Global Navigation Satellite System) receiver, and RTK (Real-Time Kinematic) or SBAS (Satellite-Based Augmentation System) can be used for error correction. Remaining fuel amount is acquired as an analog value from a float-type or capacitive sensor, and recorded as a digital value after A/D conversion. Engine status is acquired from OBD-II codes or engine diagnostic modules, including abnormal codes (e.g., P0171), temperature, and pressure values. Surrounding traffic conditions are acquired in JSON format from V2X communication (vehicle-to-vehicle and vehicle-to-infrastructure communication) or cloud APIs, including traffic flow data, congestion information, and accident information. Weather information is acquired from in-vehicle external temperature sensors, wiper operation status, and weather codes (e.g., rain, clear, snow), temperature, humidity, and precipitation from cloud weather APIs. The collection unit buffers these data as time-series tensors and applies median completion or outlier removal filters in case of missing or abnormal values. As a technical effect, the collection unit greatly improves the comprehensiveness, reliability, and immediacy of information compared to conventional systems that depend on a single information source, by integrating diverse sensor and communication data in real time and with high precision. This enables the generative AI and subsequent processing units to make more accurate and context-adaptive decisions, directly contributing to driving support and safety improvement. Application fields include personal assistants for individuals, operation management for commercial vehicles, situation awareness for emergency vehicles, and collaboration with urban traffic infrastructure.

The prompt generation unit can convert the collected information into formats such as “The current position is XX”, “The current speed is XX km/h”, and “The remaining fuel amount is XX liters”. For example, the prompt generation unit converts the collected information into a format that is easily understood by the generative AI. For example, the prompt generation unit converts position information into a format such as “The current position is XX”. The prompt generation unit can also convert speed and remaining fuel amount into formats such as “The current speed is XX km/h” and “The remaining fuel amount is XX liters”. For example, the prompt generation unit converts position information into a format such as “The current position is XX”, and speed and remaining fuel amount into formats such as “The current speed is XX km/h” and “The remaining fuel amount is XX liters”. By converting the collected information into a format that is easily understood by the generative AI, the prompt generation unit can generate appropriate responses. Specifically, the prompt generation unit automatically converts multidimensional structured data (e.g., position coordinates, speed, remaining fuel amount, engine temperature, OBD-II codes, traffic flow, weather codes, etc.) received from the collection unit into natural language text that can be optimally understood by the generative AI, using a template-based natural language generation engine or rule-based mapping table. For example, if the input data are position coordinates (35.6895,139.6917), speed 60, remaining fuel amount 12, engine temperature 90, and weather code “rain”, the prompt generation unit generates sentences such as “The current position is 35.6895,139.6917. The current speed is 60 km/h. The remaining fuel amount is 12 liters. The engine temperature is 90° C. The weather is rainy.” The prompt generation unit selects different templates and levels of detail for each information category (e.g., navigation, vehicle status, weather, traffic), and automatically adjusts sentence length and expression according to importance and driver status (e.g., estimated stress value). Furthermore, when missing data or abnormal values are detected, the prompt generation unit automatically inserts supplementary sentences such as “Unable to acquire remaining fuel amount information” to ensure input quality for the generative AI. As a technical effect, the prompt generation unit, unlike conventional simple data enumeration or manual sentence generation, realizes automatic prompt generation that considers semantic relevance and importance of information, greatly improving the understanding accuracy and response quality of the generative AI. This enhances the convenience and safety of driving support and personal assistants, reduces driver burden, and contributes to accident prevention. Application fields include in-vehicle AI assistants, operation management systems, emergency vehicle support, and smart city collaboration.

The generation unit can generate an appropriate response to a driver's question based on the information converted into prompts. For example, the generation unit generates an appropriate response to a driver's question based on the information converted into prompts. For example, if the driver asks “Where is the nearest gas station?”, the generation unit proposes the optimal gas station based on the vehicle's position information and remaining fuel amount. If the driver asks “Should I turn right at the next intersection?”, the generation unit provides appropriate advice based on surrounding traffic conditions and weather information. For example, the generation unit generates an appropriate response to a driver's question based on the information converted into prompts. By generating appropriate responses based on the information converted into prompts, the generation unit can respond quickly to the driver's questions. Specifically, the generation unit inputs the natural language text (e.g., “The current position is 35.6895,139.6917. The remaining fuel amount is 12 liters. Please tell me the nearest gas station.”) received from the prompt generation unit into a large-scale language model with billions of parameters and a Transformer architecture. The input data are converted into sequence data (e.g., token ID arrays, length 128-512) by tokenization, and sequence transformation, semantic understanding, and inference are performed in encoder-decoder layers. The generation unit generates natural language text as output (e.g., “The nearest gas station is at point A, 2 km ahead” or “Right turn is not recommended. There is congestion near the intersection.”). The output can also include confidence scores (e.g., 0.92) and option labels (e.g., “Point A”, “Point B”). Furthermore, the generation unit automatically adjusts the level of detail and expression method of response sentences according to information category (e.g., navigation, vehicle status, weather, traffic) and importance. For example, for important warning information, emphasized expressions such as “Please head to the nearest gas station immediately” are used, while for ordinary guidance information, plain expressions such as “There is a gas station at point A, 2 km ahead” are used. The generation unit sends the output to the subsequent threshold determination unit, and only sends the output to the provision unit if the confidence exceeds a certain threshold. As a technical effect, the generation unit, unlike conventional rule-based responses or manual judgment, integrates multiple real-time sensor data and performs sequence analysis, semantic understanding, and inference in high-dimensional space, greatly improving the accuracy and immediacy of responses. This enhances the safety and convenience of driving support and personal assistants, reduces driver burden, and contributes to accident prevention. Application fields include in-vehicle AI assistants, operation management systems, emergency vehicle support, and smart city collaboration.

The provision unit can provide the generated response to the driver via voice or display. For example, the provision unit provides the generated response to the driver via voice or display. The provision unit can provide the generated response by voice or display. For example, the provision unit provides the generated response to the driver via voice or display. By providing the generated response via voice or display, the provision unit enables the driver to easily obtain information. Specifically, the provision unit inputs the natural language text (e.g., “The nearest gas station is at point A, 2 km ahead”) received from the generation unit into a speech synthesis module (e.g., WaveNet-based TTS engine) and outputs it as voice waveform data (e.g., 16 kHz, 16 bit PCM). Examples of voice output include “There is a gas station at point A, 2 km ahead”. The provision unit also sends the same text to the in-vehicle display control module, displaying text or icons (e.g., gas station mark, right-turn arrow) on the GUI. Examples of display output include “Right turn is not recommended. There is congestion.” Furthermore, the provision unit automatically adjusts the output priority and expression method (e.g., emphasized voice, warning color display) of voice and display according to driver status (e.g., estimated stress value, driving situation) and information importance. For example, voice output is prioritized during highway driving, and display output is prioritized during city driving, realizing optimal information provision according to driving situation. As a technical effect, the provision unit, unlike conventional single output means or manual information transmission, integrates multiple output modalities and provides information adaptively and in real time, greatly reducing the driver's cognitive load and significantly improving the safety and convenience of driving support. Application fields include in-vehicle AI assistants, operation management systems, emergency vehicle support, and driving assistance for disabled persons.

The provision unit can provide information required by the driver while driving or information useful for supporting driving. For example, the provision unit provides information required by the driver while driving or information useful for supporting driving. For example, the provision unit can provide navigation information or traffic information. The provision unit can also provide information useful for supporting driving, such as fuel efficiency information or engine status. For example, the provision unit provides information required by the driver while driving or information useful for supporting driving. By providing necessary information or support information while driving, the provision unit supports the driver's driving. Specifically, the provision unit provides various information such as navigation information (e.g., “Please turn right at point A, 2 km ahead”), traffic information (e.g., “Currently, congestion is occurring 3 km ahead”), fuel efficiency information (e.g., “Average fuel efficiency is 15 km/L”), and engine status (e.g., “Engine temperature is within the normal range”) to the driver via a speech synthesis module or display control module. The provision unit automatically adjusts output priority and expression method (e.g., warning sound, emphasized display, detailed explanation) according to information category and importance. For example, emergency warning information is emphasized by both voice and display, while ordinary guidance information is concisely displayed only on the display. Furthermore, the provision unit can personalize output frequency and level of detail based on driver status (e.g., estimated stress value, driving situation) and past usage history. As a technical effect, the provision unit, unlike conventional uniform information provision or manual guidance, integrates and optimizes diverse driving support information in real time and adaptively, greatly reducing the driver's cognitive load and significantly improving driving efficiency, safety, and comfort. Application fields include in-vehicle AI assistants, operation management systems, emergency vehicle support, and driving assistance for disabled persons.

The collection unit can estimate the driver's emotion and adjust the timing of information collection based on the estimated emotion of the driver. For example, the collection unit estimates the driver's emotion and adjusts the timing of information collection based on the estimated emotion. For example, if the driver is feeling stressed, the collection unit reduces the frequency of information collection and collects only necessary information. If the driver is relaxed, the collection unit increases the frequency of information collection and collects detailed information. Furthermore, if the driver is in a hurry, the collection unit can preferentially collect only important information. For example, the collection unit estimates the driver's emotion and adjusts the timing of information collection based on the estimated emotion. By adjusting the timing of information collection according to the driver's emotion, the collection unit can collect information at appropriate timing. Emotion estimation is realized using, for example, an emotion engine or generative AI with emotion estimation functions. The generative AI may be a text generative AI (e.g., LLM) or a multimodal generative AI, but is not limited thereto. Specifically, the collection unit acquires multimodal data (e.g., face image tensor (224×224×3), voice waveform data (16 kHz, 16 bit PCM, 10 seconds), steering angle time series (100 Hz, 10 seconds), heart rate time series (1 Hz, 60 seconds)) in real time from internal vehicle cameras, microphones, steering sensors, and heart rate sensors. The collection unit performs preprocessing (e.g., median filter, spectral subtraction), normalization (e.g., 0-1 scaling), and feature extraction (e.g., facial expression feature vector, voice pitch/spectral features, steering operation variation, heart rate variability index) and inputs them to the emotion estimation AI. The emotion estimation AI uses, for example, convolutional neural networks (CNN) for image input, recurrent neural networks (RNN) or Transformer for voice input, and LSTM or autoregressive models for time-series biological data, and has a multimodal fusion layer (e.g., feature concatenation+fully connected layer) for integrating all features. Examples of input include combinations of face image tensor, voice spectrum, steering angle series, and heart rate series, and output includes emotion labels (e.g., “stress”, “relaxation”, “tension”, “fatigue”) as one-hot vectors or probability distributions (e.g., stress 0.72, relaxation 0.18, fatigue 0.10). The output of the emotion estimation AI is determined by the threshold determination unit (e.g., “stress level 0.7 or higher”) and input to the information collection frequency control module of the collection unit. The information collection frequency control module dynamically adjusts collection timing, frequency, and information type, for example, collecting at one-minute intervals during stress, at ten-second intervals during relaxation, and collecting only important information by event trigger when in a hurry. As a technical effect, the collection unit, unlike conventional uniform information collection, estimates the driver's emotional state, a high-dimensional and nonlinear internal state, in real time and optimizes the timing, frequency, and content of information collection accordingly, reducing communication and computational load due to unnecessary data collection and enabling high-precision information acquisition at necessary timing. This greatly improves system responsiveness, power efficiency, and user experience, directly contributing to stress reduction and safe driving support for the driver. Application fields include personal assistants for general passenger cars, operation management for commercial vehicles, stress monitoring for emergency vehicles, driving assistance for disabled persons, and health management for long-distance trucks. Furthermore, it can be applied to fleet-wide emotion state monitoring via cloud collaboration and stress distribution analysis in collaboration with urban traffic infrastructure.

The collection unit can analyze past driving history and select an appropriate information collection method. For example, the collection unit analyzes past driving history and selects an appropriate information collection method. For example, the collection unit collects necessary information based on routes frequently used by the driver in the past. The collection unit can also predict and collect information required at specific times based on the driver's past driving history. Furthermore, the collection unit can analyze the driver's past driving patterns and select an appropriate information collection method. For example, the collection unit analyzes past driving history and selects an appropriate information collection method. By analyzing past driving history, the collection unit can select an appropriate information collection method. Specifically, the collection unit accumulates vehicle driving log data (e.g., date and time, departure/destination coordinates, driving route (GPS trajectory), driving distance, average speed, fuel efficiency, traffic conditions, weather, driving events (rapid acceleration/deceleration, break timing, etc.)) as a time-series database. The collection unit applies time-series clustering algorithms (e.g., k-means, DBSCAN, self-organizing maps) and pattern mining methods (e.g., frequent route extraction, association rule mining) to analyze these history data. Examples of input include driving route series for the past 30 days (each route is a sequence of GPS coordinates, 1,000 points per route), and additional information for each route such as traffic conditions, weather, and driving events. Analysis results include patterns such as “Route A is frequently used on weekdays from 7 to 9 a.m.”, “Route B is selected on rainy days”, and “Destination C is chosen for sightseeing on holidays”. Based on these patterns, the collection unit automatically optimizes information collection targets, frequency, and timing, for example, focusing on traffic, congestion, and weather information on Route A on weekday mornings, and prioritizing parking, sightseeing, and congestion information around destination C on holidays. Furthermore, the collection unit can implement a predictive information collection mode that predicts and collects information required under specific time or weather conditions (e.g., lighting information at night, road surface conditions on rainy days) based on past driving history. As a technical effect, the collection unit, unlike conventional uniform information collection, autonomously constructs individually optimized information collection strategies by analyzing each driver's driving history and behavioral patterns as high-dimensional time-series data, reducing unnecessary information collection and enabling timely acquisition of necessary information without omissions. This reduces system-wide communication and computational load and greatly improves user experience, driving support accuracy, and efficiency. Application fields include personal assistants for individuals, operation management and efficiency improvement for commercial vehicles, route optimization for emergency vehicles, guidance optimization for sightseeing buses, and collaboration with urban traffic infrastructure. Furthermore, it can be applied to fleet-wide operation pattern analysis via cloud collaboration and feedback to urban traffic planning.

The collection unit can perform filtering during information collection based on the driver's current driving situation or area of interest. For example, the collection unit performs filtering during information collection based on the driver's current driving situation or area of interest. For example, if the driver is driving on a highway, the collection unit preferentially collects information related to highways. If the driver has a specific area of interest (e.g., sightseeing spots), the collection unit can collect information related to that area. Furthermore, the collection unit can filter and collect necessary information based on the driver's current driving situation. For example, the collection unit performs filtering during information collection based on the driver's current driving situation or area of interest. By filtering information based on the driver's driving situation or area of interest, the collection unit can efficiently collect necessary information. Specifically, the collection unit determines the vehicle's driving mode (e.g., highway driving, general road driving, parking, congestion, near destination, etc.) in real time from vehicle sensor data (e.g., speed, GPS coordinates, acceleration, road type code), and extracts the driver's area of interest (e.g., sightseeing, gourmet, shopping, historical spots, etc.) from past search history, user profile, and social media collaboration data. Examples of input include current driving mode “highway”, area of interest “sightseeing/gourmet”, and current location “Tomei Expressway, near Shizuoka”. Based on this information, the collection unit uses an information collection filtering module to preferentially acquire only highly relevant information categories such as “highway traffic information”, “service area information”, “sightseeing discount information”, and “gourmet spot information” from APIs or the cloud. Filtering algorithms may include rule-based (if-then rules), Bayesian networks, and machine learning-based relevance scoring (e.g., LightGBM, random forest). Examples of output include “optimal information category list for current driving mode”, “priority score for each category”, and “API list for collection targets”. In subsequent processing, the filtering results are input to the information collection scheduler, and information is collected in order of priority. As a technical effect, the collection unit, unlike conventional uniform information collection, analyzes high-dimensional and dynamic contexts such as the driver's driving situation and area of interest in real time and automatically filters information collection targets, greatly reducing unnecessary information acquisition and communication load while enabling timely acquisition of necessary information without omissions. This improves system-wide efficiency, responsiveness, and user experience, contributing to safe driving support and a comfortable travel experience for the driver. Application fields include personal assistants for individuals, operation management for commercial vehicles, guidance optimization for sightseeing buses, collaboration with urban traffic infrastructure, and driving assistance for disabled persons. Furthermore, it can be applied to large-scale traffic information distribution via cloud collaboration and advertising/promotion collaboration.

The collection unit can estimate the driver's emotion and determine the priority of information to be collected based on the estimated emotion of the driver. For example, the collection unit estimates the driver's emotion and determines the priority of information to be collected based on the estimated emotion. For example, if the driver is feeling stressed, the collection unit preferentially collects only important information. If the driver is relaxed, the collection unit can preferentially collect detailed information. Furthermore, if the driver is in a hurry, the collection unit can preferentially collect information that needs to be provided quickly. For example, the collection unit estimates the driver's emotion and determines the priority of information to be collected based on the estimated emotion. By determining the priority of information according to the driver's emotion, the collection unit can preferentially collect important information. Emotion estimation is realized using, for example, an emotion engine or generative AI with emotion estimation functions. The generative AI may be a text generative AI (e.g., LLM) or a multimodal generative AI, but is not limited thereto. Specifically, the collection unit preprocesses and extracts features from multimodal data (e.g., face image tensor, voice waveform, heart rate time series) acquired from internal vehicle cameras, microphones, and biometric sensors, and inputs them to an emotion estimation AI (e.g., CNN+RNN+fusion layer). Examples of input include face image (224×224×3), voice spectrum (128 dimensions×100 frames), and heart rate series (60 points). The emotion estimation AI generates emotion labels such as “stress”, “relaxation”, “tension”, “fatigue” and probability distributions (e.g., stress 0.8, relaxation 0.1, fatigue 0.1) as output. Based on the emotion estimation results, the collection unit applies rule-based or machine learning-based priority determination algorithms in the information priority determination module, such as “safety/warning information is prioritized during stress”, “detailed information is also collected during relaxation”, and “navigation/traffic information is prioritized when in a hurry”. Examples of output include “priority list for each information category” and “information collection target list”. In subsequent processing, information is acquired from APIs or sensors in order of priority by the collection scheduler. As a technical effect, the collection unit, unlike conventional uniform information collection, estimates the driver's emotional state, a high-dimensional and nonlinear internal state, in real time and dynamically optimizes the priority of information collection accordingly, reducing unnecessary information acquisition and communication load while enabling timely acquisition of important information without omissions. This improves system-wide efficiency, responsiveness, and user experience, contributing to safe driving support and stress reduction for the driver. Application fields include personal assistants for general passenger cars, operation management for commercial vehicles, stress monitoring for emergency vehicles, driving assistance for disabled persons, and health management for long-distance trucks. Furthermore, it can be applied to fleet-wide emotion state monitoring via cloud collaboration and stress distribution analysis in collaboration with urban traffic infrastructure.

The collection unit can preferentially collect highly relevant information during information collection based on the driver's geographic position information. For example, the collection unit preferentially collects highly relevant information during information collection based on the driver's geographic position information. For example, if the driver is in a specific area, the collection unit preferentially collects information related to that area. If the driver is approaching the destination, the collection unit can preferentially collect information related to the destination. Furthermore, the collection unit can preferentially collect highly relevant information based on the driver's current geographic position information. For example, the collection unit preferentially collects highly relevant information during information collection based on the driver's geographic position information. By preferentially collecting highly relevant information based on the driver's geographic position information, the collection unit can efficiently collect necessary information. Specifically, the collection unit acquires current location coordinates (latitude, longitude, altitude) in real time from the vehicle's GPS receiver or GNSS module and matches them with map databases and POI (Point of Interest) databases. Examples of input include current location “35.6895,139.6917”, destination “35.7100,139.8107”, and driving route “A→B→C”. Based on geographic position information, the collection unit uses a position information filtering module to preferentially acquire only highly relevant information categories such as “traffic information around the current location”, “parking information around the destination”, “congestion/accident information along the route”, and “region-specific sightseeing/gourmet information” from APIs or the cloud. Filtering algorithms may include spatial distance calculation (e.g., Haversine distance), geographic clustering (e.g., DBSCAN), and map matching algorithms (e.g., Hidden Markov Model). Examples of output include “information list within a 5 km radius of the current location” and “priority information list around the destination”. In subsequent processing, information is acquired from APIs or sensors in order of priority by the collection scheduler. As a technical effect, the collection unit, unlike conventional uniform information collection, analyzes high-dimensional and dynamic contexts such as the driver's geographic position in real time and automatically filters information collection targets, greatly reducing unnecessary information acquisition and communication load while enabling timely acquisition of necessary information without omissions. This improves system-wide efficiency, responsiveness, and user experience, contributing to safe driving support and a comfortable travel experience for the driver. Application fields include personal assistants for individuals, operation management for commercial vehicles, guidance optimization for sightseeing buses, collaboration with urban traffic infrastructure, and driving assistance for disabled persons. Furthermore, it can be applied to large-scale traffic information distribution via cloud collaboration and region-specific promotion collaboration.

The collection unit can analyze the driver's social media activity during information collection and collect relevant information. For example, the collection unit analyzes the driver's social media activity during information collection and collects relevant information. For example, the collection unit collects relevant information based on information shared by the driver on social media. The collection unit can also collect information related to topics of interest based on the driver's social media activity. Furthermore, the collection unit can analyze the driver's social media activity and collect necessary information. For example, the collection unit analyzes the driver's social media activity during information collection and collects relevant information. By analyzing the driver's social media activity, the collection unit can efficiently collect relevant information. Specifically, the collection unit periodically acquires text data and image data from social media APIs (e.g., timeline, post history, like history, follow list, etc.) within the scope permitted by the driver. Examples of input include the latest 30 post texts (e.g., “I want to enjoy gourmet food at the Shizuoka service area”, “Recently, touring hot spring resorts is my hobby”), image posts (e.g., sightseeing photos), and hashtags (e.g., #drive #gourmet #hot spring). The collection unit uses natural language processing AI (e.g., BERT, Transformer-based text classifier) and image recognition AI (e.g., ResNet, EfficientNet) to extract topics of interest (e.g., gourmet, sightseeing, hot springs, outdoor activities), position information, and time-series patterns from post content. The extraction results are input to the information collection filtering module, and information related to topics of interest (e.g., gourmet spot information, sightseeing discount information, event information) is preferentially acquired from APIs or the cloud. Furthermore, time-series analysis of posts enables adaptation to seasonality and recent changes in interest (e.g., sea in summer, hot springs in winter). As a technical effect, the collection unit, unlike conventional uniform information collection, autonomously constructs individually optimized information collection strategies by analyzing high-dimensional and unstructured data such as the driver's social media activity with AI, reducing unnecessary information acquisition and communication load while enabling timely acquisition of necessary information without omissions. This improves system-wide efficiency, responsiveness, and user experience, contributing to driver satisfaction and a comfortable travel experience. Application fields include personal assistants for individuals, guidance optimization for sightseeing buses, promotion collaboration for commercial vehicles, and collaboration with urban traffic infrastructure. Furthermore, it can be applied to large-scale trend analysis via cloud collaboration and advertising/promotion collaboration.

The prompt generation unit can estimate the driver's emotion and adjust the expression method of prompts based on the estimated emotion of the driver. For example, the prompt generation unit estimates the driver's emotion and adjusts the expression method of prompts based on the estimated emotion. For example, if the driver is feeling stressed, the prompt generation unit provides simple and easy-to-understand prompts. If the driver is relaxed, the prompt generation unit can provide prompts containing detailed information. Furthermore, if the driver is in a hurry, the prompt generation unit can provide prompts that can be quickly understood. For example, the prompt generation unit estimates the driver's emotion and adjusts the expression method of prompts based on the estimated emotion. By adjusting the expression method of prompts according to the driver's emotion, the prompt generation unit can provide appropriate prompts. Emotion estimation is realized using, for example, an emotion engine or generative AI with emotion estimation functions. The generative AI may be a text generative AI (e.g., LLM) or a multimodal generative AI, but is not limited thereto. Specifically, the prompt generation unit receives multimodal emotion estimation results (e.g., probability distribution such as stress 0.75, relaxation 0.15, fatigue 0.10) from the collection unit and inputs them to the prompt generation template selection module. If the output value of the emotion estimation AI is 0.7 or higher for the “stress” label, the prompt generation unit automatically selects a “short sentence/key point emphasis” template and generates concise sentences such as “The current remaining fuel amount is 12 liters. The nearest gas station is 2 km ahead.” In the case of a relaxed state (relaxation 0.7 or higher), a “detailed explanation” template is selected, and detailed sentences such as “The current remaining fuel amount is 12 liters. The nearest gas station is at point A, 2 km ahead, open 24 hours. The current traffic condition is no congestion.” are generated. In the case of being in a hurry (estimated from heart rate or steering operation), an “immediate understanding” template is selected, and extremely short prompts such as “Fuel remaining 12 L, refueling available at point A, 2 km ahead” are generated. The prompt generation unit not only selects templates but also automatically adjusts writing style (e.g., imperative, polite), presence of emphasis words (e.g., “immediately”, “attention”), and order of information (e.g., placing important information at the beginning) according to emotional state. Examples of input to the AI include emotion estimation result vectors (e.g., one-hot or softmax probability distribution) and vehicle status data (e.g., remaining fuel amount, position, speed, etc.), and examples of output include “The current remaining fuel amount is 12 liters. The nearest gas station is 2 km ahead.” or “Fuel remaining 12 L, refueling available at point A, 2 km ahead”. In subsequent processing, the generated prompt is used as input to a large-scale language model, directly contributing to response generation quality, immediacy, and reduction of driver cognitive load. As a technical effect, the prompt generation unit, unlike conventional uniform templates or manual sentence generation, realizes prompt generation that reflects the driver's emotion, a high-dimensional and nonlinear internal state, in real time, greatly improving the understanding accuracy, response quality, and user experience of the generative AI. This enhances the safety and convenience of driving support and personal assistants, reduces driver stress, and contributes to accident prevention. Application fields include in-vehicle AI assistants, operation management systems, emergency vehicle support, driving assistance for disabled persons, and health management for long-distance trucks. Furthermore, it can be applied to emotion-adaptive information distribution for entire fleets via cloud collaboration and stress distribution analysis in collaboration with urban traffic infrastructure.

The prompt generation unit can adjust the level of detail of prompts based on the importance of the information. For example, the prompt generation unit adjusts the level of detail of prompts based on the importance of the information. For example, the prompt generation unit provides detailed prompts for important information. The prompt generation unit can also provide concise prompts for less important information. Furthermore, the prompt generation unit can adjust the level of detail of prompts according to the importance of the information. For example, the prompt generation unit adjusts the level of detail of prompts based on the importance of the information. By adjusting the level of detail of prompts according to the importance of the information, the prompt generation unit can provide appropriate prompts. Specifically, the prompt generation unit applies an information importance determination module to various types of information (e.g., remaining fuel amount, engine abnormality, traffic congestion, weather changes, etc.) received from the collection unit. The information importance determination module performs rule-based (e.g., engine abnormality or low remaining fuel amount is “high”), machine learning model-based (e.g., importance scoring by LightGBM), or personalized importance estimation based on the driver's past reaction history. Examples of input include pairs of information items (e.g., remaining fuel amount 12 L, engine temperature 90° C., traffic congestion level 2, weather “rain”) and importance scores (e.g., remaining fuel amount 0.9, engine abnormality 1.0, traffic congestion 0.5, weather 0.3). For information with high importance scores (e.g., 0.8 or higher), the prompt generation unit selects a “detailed explanation” template and generates detailed sentences such as “The remaining fuel amount is 12 liters. The nearest gas station is at point A, 2 km ahead, open 24 hours. The current traffic condition is no congestion.” For information with low importance scores (e.g., 0.3 or lower), a “concise” template is selected and short sentences such as “The weather is rainy.” are generated. The prompt generation unit automatically adjusts sentence length, level of detail, order of information (placing important information at the beginning), and presence of emphasis words (e.g., “attention”, “warning”) according to importance. Examples of input to the AI include pairs of information items and importance scores, and examples of output include “The remaining fuel amount is 12 liters. The nearest gas station is at point A, 2 km ahead.” or “The weather is rainy.” In subsequent processing, the generated prompt is input to a large-scale language model, contributing to response generation accuracy, immediacy, and reduction of driver cognitive load. As a technical effect, the prompt generation unit, unlike conventional uniform templates or manual sentence generation, realizes prompt generation that reflects the importance of information, a high-dimensional and dynamic indicator, in real time, greatly improving the understanding accuracy, response quality, and user experience of the generative AI. This enhances the safety and convenience of driving support and personal assistants, reduces driver burden, and contributes to accident prevention. Application fields include in-vehicle AI assistants, operation management systems, emergency vehicle support, and driving assistance for disabled persons. Furthermore, it can be applied to optimization of important information distribution for entire fleets via cloud collaboration and emergency information transmission in collaboration with urban traffic infrastructure.

The prompt generation unit can apply different prompt generation algorithms according to the category of information. For example, the prompt generation unit applies different prompt generation algorithms according to the category of information. For example, for traffic information, the prompt generation unit applies a prompt generation algorithm that enables quick understanding. For weather information, the prompt generation unit can apply a prompt generation algorithm that includes detailed information. Furthermore, for vehicle status information, the prompt generation unit can apply a simple and easy-to-understand prompt generation algorithm. For example, the prompt generation unit applies different prompt generation algorithms according to the category of information. By applying prompt generation algorithms according to the category of information, the prompt generation unit can provide appropriate prompts. Specifically, the prompt generation unit applies an information category determination module (e.g., navigation, vehicle status, weather, traffic, entertainment, etc.) to the information received from the collection unit and automatically selects the optimal prompt generation algorithm for each category. For example, for the traffic information category, a “key point extraction” algorithm (e.g., extracting only major congestion sections, generating short sentences) is applied to generate immediately understandable sentences such as “Congestion is occurring 3 km ahead.” For the weather information category, a “detailed explanation” algorithm (e.g., integrating temperature, humidity, precipitation, and weather codes, generating multiple sentences) is applied to generate detailed sentences such as “The current weather is rainy. The temperature is 18° C., humidity is 80%, and precipitation is 5 mm/h.” For the vehicle status information category, an “anomaly detection” algorithm (e.g., OBD-II code analysis, generating warning sentences only in case of abnormality) is applied to generate simple warning sentences such as “Engine temperature is high. Inspection is recommended for safety.” The prompt generation unit automatically adjusts templates, writing style, order of information, and presence of emphasis words for each category. Examples of input to the AI include category labels and information items (e.g., category “weather”, temperature 18° C., humidity 80%, precipitation 5 mm/h), and examples of output include “The current weather is rainy. The temperature is 18° C., humidity is 80%, and precipitation is 5 mm/h.” In subsequent processing, the generated prompt is input to a large-scale language model, contributing to response generation accuracy, immediacy, and reduction of driver cognitive load. As a technical effect, the prompt generation unit, unlike conventional uniform templates or manual sentence generation, applies optimized algorithms for each information category in real time, greatly improving the understanding accuracy, response quality, and user experience of the generative AI. This enhances the safety and convenience of driving support and personal assistants, reduces driver burden, and contributes to accident prevention. Application fields include in-vehicle AI assistants, operation management systems, emergency vehicle support, driving assistance for disabled persons, and guidance optimization for sightseeing buses. Furthermore, it can be applied to optimization of category-specific information distribution via cloud collaboration and information classification distribution in collaboration with urban traffic infrastructure.

The prompt generation unit can adjust the length of prompts based on the estimated emotion of the driver. For example, the prompt generation unit estimates the driver's emotion and adjusts the length of prompts based on the estimated emotion. For example, if the driver is feeling stressed, the prompt generation unit provides short prompts that emphasize key points. If the driver is relaxed, the prompt generation unit can provide longer prompts containing detailed explanations. Furthermore, if the driver is in a hurry, the prompt generation unit can provide short prompts that can be quickly understood. For example, the prompt generation unit estimates the driver's emotion and adjusts the length of prompts based on the estimated emotion. By adjusting the length of prompts according to the driver's emotion, the prompt generation unit can provide appropriate prompts. Emotion estimation is realized using, for example, an emotion engine or generative AI with emotion estimation functions. The generative AI may be a text generative AI (e.g., LLM) or a multimodal generative AI, but is not limited thereto. Specifically, the prompt generation unit receives emotion estimation results (e.g., probability distribution such as stress 0.8, relaxation 0.1, fatigue 0.1) from the collection unit and inputs them to the prompt length control module. The prompt length control module sets optimal sentence length parameters for each emotion label (e.g., 50 characters or less during stress, up to 200 characters during relaxation, 30 characters or less when in a hurry) and instructs the template generation engine. Examples of input include emotion estimation vector and vehicle status data (e.g., remaining fuel amount, position, speed, etc.), and examples of output include “Fuel remaining 12 L, refueling available at point A, 2 km ahead” (short sentence) or “The current remaining fuel amount is 12 liters. The nearest gas station is at point A, 2 km ahead, open 24 hours. The current traffic condition is no congestion.” (long sentence). The prompt generation unit automatically adjusts not only sentence length but also level of detail, order of information, and presence of emphasis words according to emotional state. In subsequent processing, the generated prompt is input to a large-scale language model, directly contributing to response generation quality, immediacy, and reduction of driver cognitive load. As a technical effect, the prompt generation unit, unlike conventional uniform templates or manual sentence generation, realizes prompt length control that reflects the driver's emotion, a high-dimensional and nonlinear internal state, in real time, greatly improving the understanding accuracy, response quality, and user experience of the generative AI. This enhances the safety and convenience of driving support and personal assistants, reduces driver stress, and contributes to accident prevention. Application fields include in-vehicle AI assistants, operation management systems, emergency vehicle support, driving assistance for disabled persons, and health management for long-distance trucks. Furthermore, it can be applied to emotion-adaptive information distribution for entire fleets via cloud collaboration and stress distribution analysis in collaboration with urban traffic infrastructure.

The prompt generation unit can determine the priority of prompts based on the timing of information collection. For example, the prompt generation unit determines the priority of prompts based on the timing of information collection. For example, the prompt generation unit provides prompts for the latest information with priority. The prompt generation unit can also lower the priority of prompts for older information. Furthermore, the prompt generation unit can determine the priority of prompts according to the timing of information collection. For example, the prompt generation unit determines the priority of prompts based on the timing of information collection. By determining the priority of prompts based on the timing of information collection, the prompt generation unit can preferentially provide the latest information. Specifically, the prompt generation unit attaches collection timestamps (e.g., UNIX epoch seconds, ISO8601 format) to each information item received from the collection unit and quantitatively manages the freshness of information. When generating prompts, the prompt generation unit applies an “information freshness determination module” and calculates the difference between the collection time of each information item and the current time (e.g., in seconds, minutes, hours). Examples of input include remaining fuel amount “12 L” (collection time: 2024-06-01T10:00:00Z), engine temperature “90° C.” (collection time: 2024-06-01T09:59:30Z), traffic information “congestion” (collection time: 2024-06-01T09:58:00Z), etc. The prompt generation unit calculates an information freshness score (e.g., 1.0=latest, 0.0=old) and arranges information with higher scores at the beginning of the prompt sentence. For example, information with a freshness score of 0.9 or higher is described with priority, such as “The current remaining fuel amount is 12 liters.”, and information with a score below 0.5 is described supplementarily, such as “As reference information, traffic conditions were congested one hour ago.” The prompt generation unit automatically adjusts writing style (e.g., present tense, past tense) and presence of emphasis words (e.g., “latest”, “reference”) according to information freshness. Examples of input to the AI include pairs of information items, collection time, and freshness score, and examples of output include “The current remaining fuel amount is 12 liters. As reference information, traffic conditions were congested one hour ago.” In subsequent processing, the generated prompt is input to a large-scale language model, contributing to response generation accuracy, immediacy, and reduction of driver cognitive load. As a technical effect, the prompt generation unit, unlike conventional uniform information enumeration or manual sentence generation, realizes prompt priority control that reflects the timing of information collection, a high-dimensional and dynamic indicator, in real time, greatly improving the understanding accuracy, response quality, and user experience of the generative AI. This enhances the safety and convenience of driving support and personal assistants, reduces driver burden, and contributes to accident prevention. Application fields include in-vehicle AI assistants, operation management systems, emergency vehicle support, driving assistance for disabled persons, and health management for long-distance trucks. Furthermore, it can be applied to optimization of freshness-based information distribution for entire fleets via cloud collaboration and real-time information transmission in collaboration with urban traffic infrastructure.

The prompt generation unit can adjust the order of prompts based on the relevance of the information. For example, the prompt generation unit adjusts the order of prompts based on the relevance of the information. For example, the prompt generation unit provides prompts for highly relevant information with priority. The prompt generation unit can also provide prompts for less relevant information later. Furthermore, the prompt generation unit can adjust the order of prompts according to the relevance of the information. For example, the prompt generation unit adjusts the order of prompts based on the relevance of the information. By adjusting the order of prompts based on the relevance of the information, the prompt generation unit can preferentially provide highly relevant information. Specifically, the prompt generation unit applies a relevance determination module to each information item received from the collection unit, calculates a relevance score (e.g., 0.0-1.0) for each information item based on the driver's current question, driving situation, area of interest, and past usage history. Relevance determination may use rule-based methods (e.g., if the question is “Where is the nearest gas station?”, remaining fuel amount and position information are highly relevant), machine learning models (e.g., relevance estimation by LightGBM), and natural language processing AI (e.g., semantic similarity calculation between question and information item by BERT). Examples of input include question “Where is the nearest gas station?”, information items “remaining fuel amount 12 L (relevance 0.95)”, “position information 35.6895,139.6917 (relevance 0.90)”, “weather rainy (relevance 0.20)”, etc. The prompt generation unit arranges information with higher relevance scores at the beginning of the prompt sentence, and information with lower scores at the end or omits them. Examples of output include “The current remaining fuel amount is 12 liters. The current position is 35.6895,139.6917. The weather is rainy.” The prompt generation unit automatically adjusts sentence length, level of detail, and presence of emphasis words (e.g., “especially important”) according to relevance. In subsequent processing, the generated prompt is input to a large-scale language model, contributing to response generation accuracy, immediacy, and reduction of driver cognitive load. As a technical effect, the prompt generation unit, unlike conventional uniform information enumeration or manual sentence generation, realizes prompt order control that reflects the relevance of information, a high-dimensional and dynamic indicator, in real time, greatly improving the understanding accuracy, response quality, and user experience of the generative AI. This enhances the safety and convenience of driving support and personal assistants, reduces driver burden, and contributes to accident prevention. Application fields include in-vehicle AI assistants, operation management systems, emergency vehicle support, driving assistance for disabled persons, and guidance optimization for sightseeing buses. Furthermore, it can be applied to optimization of relevance-based information distribution via cloud collaboration and information classification distribution in collaboration with urban traffic infrastructure.

The generation unit can estimate the driver's emotion and adjust the method of expressing responses based on the estimated emotion of the driver. For example, the generation unit estimates the driver's emotion and adjusts the method of expressing responses according to the estimated emotion. For instance, when the driver is feeling stressed, the generation unit provides simple and easy-to-understand responses. When the driver is relaxed, the generation unit can provide responses containing detailed information. Furthermore, when the driver is in a hurry, the generation unit can provide responses that can be quickly understood. Specifically, the generation unit receives emotion estimation results (e.g., probability distribution such as stress 0.8, relaxation 0.1, fatigue 0.1) from the collection unit or the prompt generation unit as input and inputs them to the response expression control module. If the output value of the emotion estimation AI is 0.7 or higher for the “stress” label, the generation unit automatically selects a “short sentence/key point emphasis” response generation template and generates concise sentences such as “There is a gas station at point A, 2 km ahead.” In contrast, in a relaxed state (relaxation 0.7 or higher), the “detailed explanation” template is selected, generating sentences such as “There is a gas station at point A, 2 km ahead. Business hours are 24 hours, and there is no traffic congestion at present.” When the driver is in a hurry (estimated from heart rate or steering operation), the “immediate understanding” template is selected, generating extremely short responses such as “Refueling available at point A, 2 km ahead.” In addition to template selection, the generation unit automatically adjusts the writing style (e.g., imperative, polite), presence of emphasis words (e.g., “immediately,” “attention”), and the order of information (e.g., placing important information at the beginning) according to the emotional state. Examples of input to the AI include emotion estimation result vectors (e.g., one-hot or softmax probability distribution) plus prompt text, and examples of output include “There is a gas station at point A, 2 km ahead.” or “Refueling available at point A, 2 km ahead.” The generated response is then sent to the provision unit for use in speech synthesis or display. As a technical effect, the generation unit, unlike conventional uniform templates or manual sentence generation, realizes response expression control that reflects the driver's high-dimensional, nonlinear internal state (emotion) in real time, thereby greatly improving the understanding accuracy, response quality, and user experience of the generation AI. This enhances the safety and convenience of driving assistance and personal assistants, contributing to stress reduction and accident prevention for drivers. Application fields include in-vehicle AI assistants, fleet management systems, emergency vehicle support, driving assistance for disabled persons, and health management for long-distance trucks. Furthermore, it can be applied to emotion-adaptive information distribution for entire fleets via cloud collaboration and stress distribution analysis in cooperation with urban traffic infrastructure.

The generation unit can adjust the level of detail of responses during response generation based on the importance of the information. For example, the generation unit adjusts the level of detail of responses according to the importance of the information when generating responses. For important information, the generation unit provides detailed responses. For less important information, the generation unit can provide concise responses. Furthermore, the generation unit can adjust the level of detail of responses according to the importance of the information. Specifically, the generation unit applies an information importance determination module to each information item (e.g., remaining fuel amount, engine abnormality, traffic congestion, weather changes, etc.) received from the prompt generation unit. The information importance determination module performs rule-based (e.g., engine abnormality or low remaining fuel amount is “high”), machine learning model-based (e.g., importance scoring using LightGBM), or personalized importance estimation based on the driver's past reaction history. Examples of input include each information item (e.g., remaining fuel amount 12 L, engine temperature 90° C., traffic congestion level 2, weather “rain”) plus importance scores (e.g., remaining fuel amount 0.9, engine abnormality 1.0, traffic congestion 0.5, weather 0.3). For information with a high importance score (e.g., 0.8 or higher), the generation unit selects a “detailed explanation” template and generates detailed responses such as “The remaining fuel amount is 12 liters. The nearest gas station is at point A, 2 km ahead, and is open 24 hours. There is no traffic congestion at present.” For information with low importance (e.g., 0.3 or lower), the generation unit selects a “concise” template and generates short sentences such as “The weather is rainy.” The generation unit automatically adjusts the sentence length, level of detail, order of information (placing important information at the beginning), and presence of emphasis words (e.g., “attention,” “warning”) according to the importance. Examples of input to the AI include pairs of information items and importance scores, and examples of output include “The remaining fuel amount is 12 liters. The nearest gas station is at point A, 2 km ahead.” or “The weather is rainy.” The generated response is then sent to the provision unit for use in speech synthesis or display. As a technical effect, the generation unit, unlike conventional uniform templates or manual sentence generation, realizes response generation that reflects the high-dimensional, dynamic indicator of information importance in real time, thereby greatly improving the understanding accuracy, response quality, and user experience of the generation AI. This enhances the safety and convenience of driving assistance and personal assistants, contributing to reducing the driver's burden and preventing accidents. Application fields include in-vehicle AI assistants, fleet management systems, emergency vehicle support, and driving assistance for disabled persons. Furthermore, it can be applied to optimization of important information distribution for entire fleets via cloud collaboration and emergency information transmission in cooperation with urban traffic infrastructure.

The generation unit can apply different generation algorithms during response generation according to the category of information. For example, the generation unit applies different generation algorithms according to the category of information when generating responses. For traffic information, the generation unit applies a generation algorithm that enables quick understanding. For weather information, the generation unit can apply a generation algorithm that includes detailed information. For vehicle status information, the generation unit can apply a simple and easy-to-understand generation algorithm. Specifically, the generation unit applies an information category determination module (e.g., navigation, vehicle status, weather, traffic, entertainment, etc.) to the information received from the prompt generation unit and automatically selects the optimal response generation algorithm for each category. For example, for the traffic information category, a “key point extraction” algorithm (e.g., extracting only major congestion sections, generating short sentences) is applied to generate responses such as “Congestion is occurring 3 km ahead.” For the weather information category, a “detailed explanation” algorithm (e.g., integrating temperature, humidity, precipitation, weather code, generating multiple sentences) is applied to generate detailed responses such as “The current weather is rainy. The temperature is 18° C., humidity is 80%, and precipitation is 5 mm/h.” For the vehicle status information category, an “anomaly detection” algorithm (e.g., OBD-II code analysis, generating warning sentences only in case of abnormality) is applied to generate simple warning responses such as “The engine temperature is high. Inspection is recommended for safety.” The generation unit automatically adjusts templates, writing style, order of information, and presence of emphasis words for each category. Examples of input to the AI include category labels plus information items (e.g., category “weather,” temperature 18° C., humidity 80%, precipitation 5 mm/h), and examples of output include “The current weather is rainy. The temperature is 18° C., humidity is 80%, and precipitation is 5 mm/h.” The generated response is then sent to the provision unit for use in speech synthesis or display. As a technical effect, the generation unit, unlike conventional uniform templates or manual sentence generation, applies optimized algorithms for each information category in real time, thereby greatly improving the understanding accuracy, response quality, and user experience of the generation AI. This enhances the safety and convenience of driving assistance and personal assistants, contributing to reducing the driver's burden and preventing accidents. Application fields include in-vehicle AI assistants, fleet management systems, emergency vehicle support, driving assistance for disabled persons, and optimization of guidance for sightseeing buses. Furthermore, it can be applied to optimization of category-specific information distribution for entire fleets via cloud collaboration and information classification distribution in cooperation with urban traffic infrastructure.

The generation unit can estimate the driver's emotion and adjust the length of responses based on the estimated emotion of the driver. For example, the generation unit estimates the driver's emotion and adjusts the length of responses according to the estimated emotion. When the driver is feeling stressed, the generation unit provides short and concise responses. When the driver is relaxed, the generation unit can provide longer responses containing detailed explanations. Furthermore, when the driver is in a hurry, the generation unit can provide short responses that can be quickly understood. Specifically, the generation unit receives emotion estimation results (e.g., probability distribution such as stress 0.8, relaxation 0.1, fatigue 0.1) from the collection unit or the prompt generation unit as input and inputs them to the response length control module. The response length control module sets optimal sentence length parameters for each emotion label (e.g., within 50 characters for stress, up to 200 characters for relaxation, within 30 characters for being in a hurry) and instructs the template generation engine. Examples of input include emotion estimation vectors plus prompt text, and examples of output include “Refueling available at point A, 2 km ahead” (short sentence) or “There is a gas station at point A, 2 km ahead. Business hours are 24 hours, and there is no traffic congestion at present.” (long sentence). The generation unit automatically adjusts not only the sentence length but also the level of detail, order of information, and presence of emphasis words according to the emotional state. The generated response is then sent to the provision unit for use in speech synthesis or display. As a technical effect, the generation unit, unlike conventional uniform templates or manual sentence generation, realizes response length control that reflects the driver's high-dimensional, nonlinear internal state (emotion) in real time, thereby greatly improving the understanding accuracy, response quality, and user experience of the generation AI. This enhances the safety and convenience of driving assistance and personal assistants, contributing to stress reduction and accident prevention for drivers. Application fields include in-vehicle AI assistants, fleet management systems, emergency vehicle support, driving assistance for disabled persons, and health management for long-distance trucks. Furthermore, it can be applied to emotion-adaptive information distribution for entire fleets via cloud collaboration and stress distribution analysis in cooperation with urban traffic infrastructure.

The generation unit can determine the priority of responses during response generation based on the timing of information collection. For example, the generation unit determines the priority of responses according to the timing of information collection when generating responses. For the latest information, the generation unit provides responses with higher priority. For older information, the generation unit can lower the priority when providing responses. Furthermore, the generation unit can determine the priority of responses according to the timing of information collection. Specifically, the generation unit assigns a collection timestamp (e.g., UNIX epoch seconds, ISO8601 format) to each information item received from the prompt generation unit and quantitatively manages the freshness of the information. During response generation, the generation unit applies an “information freshness determination module” and calculates the difference between the collection time of each information item and the current time (e.g., in seconds, minutes, hours). Examples of input include remaining fuel amount “12 L” (collection time: 2024-06-01T10:00:00Z), engine temperature “90° C.” (collection time: 2024-06-01T09:59:30Z), traffic information “congestion” (collection time: 2024-06-01T09:58:00Z), etc. The generation unit calculates an information freshness score (e.g., 1.0=latest, 0.0=old) and arranges the information in the response sentence in order from the highest score. For example, information with a freshness score of 0.9 or higher is described with priority, such as “The current remaining fuel amount is 12 liters.” Information with a score below 0.5 is described supplementarily, such as “As reference information, the traffic situation one hour ago was congested.” The generation unit automatically adjusts the writing style (e.g., present tense, past tense) and presence of emphasis words (e.g., “latest,” “reference”) according to the freshness of the information. Examples of input to the AI include pairs of information items, collection time, and freshness score, and examples of output include “The current remaining fuel amount is 12 liters. As reference information, the traffic situation one hour ago was congested.” The generated response is then sent to the provision unit for use in speech synthesis or display. As a technical effect, the generation unit, unlike conventional uniform information enumeration or manual sentence generation, realizes response priority control that reflects the high-dimensional, dynamic indicator of information collection timing in real time, thereby greatly improving the understanding accuracy, response quality, and user experience of the generation AI. This enhances the safety and convenience of driving assistance and personal assistants, contributing to reducing the driver's burden and preventing accidents. Application fields include in-vehicle AI assistants, fleet management systems, emergency vehicle support, driving assistance for disabled persons, and health management for long-distance trucks. Furthermore, it can be applied to optimization of freshness-based information distribution for entire fleets via cloud collaboration and real-time information transmission in cooperation with urban traffic infrastructure.

The generation unit can adjust the order of responses during response generation based on the relevance of the information. For example, the generation unit adjusts the order of responses according to the relevance of the information when generating responses. For highly relevant information, the generation unit provides responses with higher priority. For less relevant information, the generation unit can provide responses later or omit them. Furthermore, the generation unit can adjust the order of responses according to the relevance of the information. Specifically, the generation unit applies a relevance determination module to each information item received from the prompt generation unit, calculates a relevance score (e.g., 0.0 to 1.0) for each information item using the driver's current question, driving situation, area of interest, and past usage history as input. Relevance determination uses rule-based methods (e.g., if the question is “Where is the nearest gas station?” then remaining fuel amount and position information are highly relevant), machine learning models (e.g., relevance estimation using LightGBM), or natural language processing AI (e.g., semantic similarity calculation between question and information item using BERT). Examples of input include question “Where is the nearest gas station?”, information items “remaining fuel amount 12 L (relevance 0.95)”, “position information 35.6895,139.6917 (relevance 0.90)”, “weather rainy (relevance 0.20)”, etc. The generation unit arranges the response sentences in order from the highest relevance score, and places less relevant information at the end or omits it. Examples of output include “The current remaining fuel amount is 12 liters. The current position is 35.6895,139.6917. The weather is rainy.” The generation unit automatically adjusts the sentence length, level of detail, and presence of emphasis words (e.g., “especially important”) according to the relevance. The generated response is then sent to the provision unit for use in speech synthesis or display. As a technical effect, the generation unit, unlike conventional uniform information enumeration or manual sentence generation, realizes response order control that reflects the high-dimensional, dynamic indicator of information relevance in real time, thereby greatly improving the understanding accuracy, response quality, and user experience of the generation AI. This enhances the safety and convenience of driving assistance and personal assistants, contributing to reducing the driver's burden and preventing accidents. Application fields include in-vehicle AI assistants, fleet management systems, emergency vehicle support, driving assistance for disabled persons, and optimization of guidance for sightseeing buses. Furthermore, it can be applied to optimization of relevance-based information distribution for entire fleets via cloud collaboration and information classification distribution in cooperation with urban traffic infrastructure.

The provision unit can estimate the driver's emotion and adjust the method of providing information based on the estimated emotion of the driver. For example, the provision unit estimates the driver's emotion and adjusts the method of providing information according to the estimated emotion. When the driver is feeling stressed, the provision unit provides information in a simple and easy-to-understand manner. When the driver is relaxed, the provision unit can provide information in a manner that includes detailed information. Furthermore, when the driver is in a hurry, the provision unit can provide information in a way that enables quick understanding. Specifically, the provision unit receives emotion estimation results (e.g., probability distribution vector such as stress 0.85, relaxation 0.10, fatigue 0.05) from the collection unit or the prompt generation unit as input and inputs them to the information provision control module. The provision unit uses multimodal data such as face image tensors (224×224×3), voice spectra (128 dimensions×100 frames), and heart rate time series (60 points), which are analyzed by CNN, RNN, and fusion layers to output emotion labels and probability distributions. Examples of input include combinations of face images, voice, and heart rate data, and examples of output include “stress 0.85, relaxation 0.10, fatigue 0.05” or “relaxation 0.70, stress 0.20, fatigue 0.10.” The information provision control module selects the optimal information provision means, expression method, and output modality (voice, display, vibration, etc.) for each emotion label. For example, in stressful situations, voice output is prioritized and short sentence/key point emphasis expressions (e.g., “Refueling available at point A, 2 km ahead”) are selected; in relaxed situations, detailed explanation templates (e.g., “There is a gas station at point A, 2 km ahead. Business hours are 24 hours.”) are selected; and in urgent situations, extremely short voice or display outputs (e.g., “Right turn recommended”) are selected. Furthermore, the provision unit instructs the voice synthesis module (e.g., WaveNet-based TTS) or display control module regarding output priority, writing style, and presence of emphasis words (e.g., “attention,” “immediately”). Examples of input to the AI include emotion estimation vector, information category, and information detail level, and examples of output include “Refueling available at point A, 2 km ahead” (voice) or “There is a gas station at point A, 2 km ahead. Business hours are 24 hours.” (display). The generated information provision instructions are sent to output modules such as voice synthesis, display, and vibration, enabling information transmission optimized for the driver's state. As a technical effect, the provision unit, unlike conventional uniform information provision or manual guidance, realizes information provision control that reflects the driver's high-dimensional, nonlinear internal state (emotion) in real time, thereby simultaneously achieving reduced cognitive load, improved information transmission efficiency, and enhanced user experience. This enhances the safety and convenience of driving assistance and personal assistants, contributing to stress reduction and accident prevention for drivers. Application fields include in-vehicle AI assistants, fleet management systems, emergency vehicle support, driving assistance for disabled persons, and health management for long-distance trucks. Furthermore, it can be applied to emotion-adaptive information distribution for entire fleets via cloud collaboration and stress distribution analysis in cooperation with urban traffic infrastructure.

The provision unit can refer to the driver's past driving history when providing information and select an appropriate provision method. For example, the provision unit refers to the driver's past driving history when providing information and selects the optimal method based on the information provision methods previously used by the driver. The provision unit can also select an information provision method suitable for specific time periods based on the driver's past driving history. Furthermore, the provision unit can analyze the driver's past driving patterns and select the optimal information provision method. Specifically, the provision unit accumulates past driving history data received from the collection unit (e.g., date and time, driving route, driving distance, average speed, information provision means used (voice, display, vibration, etc.), driver's reaction when receiving information (e.g., response speed, number of confirmations)) as a time-series database. The provision unit applies time-series clustering algorithms (e.g., k-means, DBSCAN) and pattern mining methods (e.g., frequent provision means extraction, time-of-day usage trend analysis) to analyze these history data. Examples of input include information provision history for the past 30 days (each history is a set of provision means, time period, driving situation, and driver reaction), and usage trends for each time period (e.g., voice prioritized on weekday mornings, display prioritized at night). Analysis results include patterns such as “voice output is preferred on weekday mornings from 7 to 9 am,” “display output is more common at night,” and “vibration notification is effective when driving on highways.” The provision unit refers to these patterns and automatically selects the optimal information provision means, expression method, and output priority according to the current time period, driving situation, and past usage trends when providing information. Furthermore, the provision unit constructs individually optimized (personalized) information provision strategies for each driver to improve user experience. Examples of input to the AI include current driving situation, past information provision history, and time period information, and examples of output include “voice output prioritized,” “display output prioritized,” “vibration notification combined,” etc. The selected information provision means are instructed to the voice synthesis, display control, and vibration control modules, and information is provided in real time. As a technical effect, the provision unit, unlike conventional uniform information provision or manual guidance, autonomously constructs individually optimized information provision strategies by analyzing each driver's driving history and behavioral patterns as high-dimensional time-series data, thereby reducing unnecessary information transmission and ensuring that necessary information is transmitted without omission and in a timely manner. This greatly improves the efficiency, user experience, driving assistance accuracy, and convenience of the entire system. Application fields include personal assistants for individuals, commercial vehicle operation management and efficiency improvement, optimization of information transmission for emergency vehicles, optimization of guidance for sightseeing buses, and urban traffic infrastructure collaboration. Furthermore, it can be applied to analysis of information provision patterns for entire fleets via cloud collaboration and feedback to urban traffic planning.

The provision unit can customize the means of provision during information provision based on the driver's current driving situation. For example, the provision unit customizes the means of provision according to the driver's current driving situation when providing information. For instance, when the driver is driving on a highway, the provision unit prioritizes information provision by voice. When the driver is driving in an urban area, the provision unit can prioritize visual information provision. Furthermore, the provision unit can customize the optimal information provision means according to the driver's current driving situation. Specifically, the provision unit analyzes driving situation data received from the collection unit (e.g., driving mode (highway, general road, parked, in traffic jam), speed, acceleration, GPS coordinates, road type code) in real time. The driving situation determination module determines the current driving mode based on these data and outputs labels such as “driving on highway,” “driving in urban area,” or “parked.” Examples of input include speed 100 km/h plus road type “highway”→“driving on highway,” speed 30 km/h plus road type “urban area”→“driving in urban area,” etc. The provision unit automatically selects the optimal information provision means, expression method, and output priority for each driving mode. For example, when driving on a highway, voice output is prioritized and display output is minimized. When driving in an urban area, display output is prioritized, utilizing detailed map displays and icon displays. When parked, detailed information and settings screens are provided on the display. Furthermore, the provision unit instructs the voice synthesis module or display control module regarding output priority, writing style, and presence of emphasis words (e.g., “attention,” “warning”) according to the driving situation. Examples of input to the AI include driving mode label, information category, and information detail level, and examples of output include “voice output prioritized,” “display output prioritized,” “vibration notification combined,” etc. The selected information provision means are instructed to the voice synthesis, display control, and vibration control modules, and information is provided in real time. As a technical effect, the provision unit, unlike conventional uniform information provision or manual guidance, automatically customizes the information provision means by analyzing the driver's driving situation as high-dimensional, dynamic context in real time, thereby simultaneously achieving reduced cognitive load, improved information transmission efficiency, and enhanced user experience. This enhances the safety and convenience of driving assistance and personal assistants, contributing to stress reduction and accident prevention for drivers. Application fields include in-vehicle AI assistants, fleet management systems, emergency vehicle support, driving assistance for disabled persons, and optimization of guidance for sightseeing buses. Furthermore, it can be applied to large-scale traffic information distribution via cloud collaboration and cooperation with urban traffic infrastructure.

The provision unit can estimate the driver's emotion and determine the priority of information provision based on the estimated emotion of the driver. For example, the provision unit estimates the driver's emotion and determines the priority of information provision according to the estimated emotion. When the driver is feeling stressed, the provision unit prioritizes only important information. When the driver is relaxed, the provision unit can prioritize detailed information. Furthermore, when the driver is in a hurry, the provision unit can prioritize information that needs to be provided quickly. Specifically, the provision unit receives emotion estimation results (e.g., probability distribution such as stress 0.8, relaxation 0.1, fatigue 0.1) from the collection unit or the prompt generation unit as input and inputs them to the information provision priority determination module. The information provision priority determination module applies rule-based or machine learning-based algorithms to determine the optimal information category, level of detail, and output order for each emotion label. For example, in stressful situations, safety and warning information are prioritized; in relaxed situations, detailed information is also provided; and in urgent situations, navigation and traffic information are prioritized. Examples of input to the AI include emotion estimation vector, information category, and information importance, and examples of output include “priority list by information category,” “output order list,” etc. The information with higher priority is sent to the voice synthesis and display control modules in order and provided in real time. As a technical effect, the provision unit, unlike conventional uniform information provision or manual guidance, realizes information provision priority control that reflects the driver's high-dimensional, nonlinear internal state (emotion) in real time, thereby simultaneously achieving reduced cognitive load, improved information transmission efficiency, and enhanced user experience. This enhances the safety and convenience of driving assistance and personal assistants, contributing to stress reduction and accident prevention for drivers. Application fields include in-vehicle AI assistants, fleet management systems, emergency vehicle support, driving assistance for disabled persons, and health management for long-distance trucks. Furthermore, it can be applied to emotion-adaptive information distribution for entire fleets via cloud collaboration and stress distribution analysis in cooperation with urban traffic infrastructure.

The provision unit can select an appropriate provision method during information provision based on the driver's geographic position information. For example, the provision unit selects an appropriate provision method according to the driver's geographic position information when providing information. For instance, when the driver is in a specific area, the provision unit prioritizes information related to that area. When the driver is approaching the destination, the provision unit can prioritize information related to the destination. Furthermore, the provision unit can select the optimal information provision method according to the driver's current geographic position information. Specifically, the provision unit matches current location coordinates (latitude, longitude, altitude), destination information, and driving route information received from the collection unit with map databases and POI databases. The position information determination module determines which area, road section, or vicinity of the destination the current location is in and extracts region-specific information provision needs (e.g., tourist spots, urban areas, mountainous areas, highways, etc.). Examples of input include current location “35.6895,139.6917,” destination “35.7100,139.8107,” driving route “A→B→C,” etc. The provision unit automatically selects the optimal information provision means, expression method, and output priority for each region or destination. For example, near tourist spots, tourist guidance and event information are displayed in detail on the display; in urban areas, traffic and congestion information are provided immediately by voice; and near the destination, parking information and arrival notifications are transmitted by vibration notification. Furthermore, the provision unit instructs the voice synthesis, display control, and vibration control modules regarding output priority, writing style, and presence of emphasis words according to the geographic context. Examples of input to the AI include current location coordinates, region label, and information category, and examples of output include “tourist guidance display prioritized,” “traffic information voice prioritized,” “parking information vibration notification,” etc. The selected information provision means are instructed to each output module and information is provided in real time. As a technical effect, the provision unit, unlike conventional uniform information provision or manual guidance, automatically optimizes the information provision means by analyzing the driver's geographic position as high-dimensional, dynamic context in real time, thereby simultaneously achieving reduced cognitive load, improved information transmission efficiency, and enhanced user experience. This enhances the safety and convenience of driving assistance and personal assistants, contributing to stress reduction and accident prevention for drivers. Application fields include in-vehicle AI assistants, fleet management systems, optimization of guidance for sightseeing buses, urban traffic infrastructure collaboration, and driving assistance for disabled persons. Furthermore, it can be applied to large-scale traffic information distribution via cloud collaboration and region-specific promotion collaboration.

The provision unit can analyze the driver's social media activity during information provision and propose means of provision. For example, the provision unit analyzes the driver's social media activity during information provision and proposes means of provision. For instance, the provision unit provides related information based on information shared by the driver on social media. The provision unit can also provide information related to topics of interest extracted from the driver's social media activity. Furthermore, the provision unit can analyze the driver's social media activity and propose the optimal information provision means. Specifically, the provision unit analyzes data such as post text, images, hashtags, and location information obtained via social media APIs from the collection unit using natural language processing AI (e.g., BERT, Transformer-based classifiers) and image recognition AI (e.g., ResNet, EfficientNet). Examples of input include the latest 30 post texts (e.g., “I want to enjoy gourmet food at a service area in Shizuoka”), image posts (e.g., photos of tourist spots), hashtags (e.g., #drive #gourmet #onsen), etc. The provision unit prioritizes information categories (e.g., gourmet spot information, tourist spot discount information, event information) related to extracted topics of interest (e.g., gourmet, tourist spots, hot springs, outdoor activities), location information, and time-series patterns. Furthermore, the provision unit automatically proposes the optimal information provision means for each topic of interest (e.g., gourmet information is prioritized for display, tourist spot information is prioritized for voice guidance, event information is prioritized for vibration notification). Examples of input to the AI include topic of interest, location information, and information category, and examples of output include “gourmet information display prioritized,” “tourist spot information voice prioritized,” “event information vibration notification,” etc. The proposed information provision means are instructed to the voice synthesis, display control, and vibration control modules, and information is provided in real time. As a technical effect, the provision unit, unlike conventional uniform information provision or manual guidance, autonomously constructs individually optimized information provision strategies by analyzing the driver's social media activity as high-dimensional, unstructured data using AI, thereby reducing unnecessary information transmission and ensuring that necessary information is transmitted without omission and immediately. This improves the overall system efficiency, responsiveness, and user experience, contributing to driver satisfaction and a comfortable travel experience. Application fields include personal assistants for individuals, optimization of guidance for sightseeing buses, commercial vehicle promotion collaboration, and urban traffic infrastructure collaboration. Furthermore, it can be applied to large-scale trend analysis via cloud collaboration and advertising/promotion collaboration.

The system according to the embodiment is not limited to the examples described above and can be variously modified as follows. Specifically, the system can flexibly change the configuration and algorithms of each module for information collection, prompt generation, response generation, and information provision according to the type of vehicle (passenger car, commercial vehicle, bus, emergency vehicle, etc.), driving environment (urban area, suburban area, mountainous area, highway, etc.), and driver attributes (age, driving experience, health status, etc.). For example, for commercial vehicles, functions for operation management, fuel efficiency optimization, and health management can be enhanced, and for emergency vehicles, priority route guidance, emergency information transmission, and stress monitoring functions can be added. Furthermore, the AI model architecture can be selected according to the application and computational resources, such as lightweight models (e.g., DistilTransformer), distributed inference models (e.g., cloud-connected large language models), and edge inference models (e.g., real-time inference using in-vehicle GPU). Data flow can also be configured in various ways, including local processing, cloud collaboration, fleet-wide information sharing, and urban traffic infrastructure collaboration. Information provision means can be optimized by combining multiple modalities, such as voice, display, vibration, AR head-up display, and smartphone collaboration. Furthermore, various functional extensions are possible, including AI-based anomaly detection, predictive maintenance, time-series forecasting, automatic reporting in case of abnormality, health management, entertainment recommendation, driving skill evaluation, and reward system collaboration. As a technical effect, the system, unlike conventional fixed in-vehicle information systems, adopts an architecture that allows flexible and dynamic changes to AI, data flow, output modalities, and functional configuration, thereby realizing information provision, driving assistance, safety improvement, and user experience enhancement optimized for any driving environment, user attribute, or vehicle application. As a result, it can be deployed in extremely wide-ranging application fields, including personal assistants for individuals, commercial vehicle operation management, emergency vehicle support, optimization of guidance for sightseeing buses, urban traffic infrastructure collaboration, driving assistance for disabled persons, health management, entertainment recommendation, and fleet-wide operation optimization.

The collection unit can analyze the driver's driving style based on information acquired from internal sensors of the vehicle. For example, the collection unit records the frequency of rapid acceleration and sudden braking and evaluates the driver's driving style. The collection unit can also analyze the vehicle's driving distance and fuel efficiency data to understand the driver's eco-driving tendencies. Furthermore, the collection unit can record the driver's driving time and frequency of breaks to estimate fatigue level. Thus, the collection unit can provide advice tailored to the driver's driving style. Specifically, the collection unit acquires high-frequency time-series data (e.g., at 1-second or 100 ms intervals) from multiple internal sensors such as vehicle acceleration sensors, brake pressure sensors, steering angle sensors, fuel flow meters, odometers, in-vehicle cameras, and heart rate sensors. The collection unit buffers these sensor data as multidimensional tensors (e.g., 3-axis acceleration×1000 samples, brake pressure×1000 samples, fuel consumption×1000 samples, etc.) and performs preprocessing such as noise removal (e.g., moving average, low-pass filter), outlier removal, and normalization. Examples of input for one driving session include “acceleration time series (1000 points),” “brake pressure time series (1000 points),” “fuel consumption (liters/100 km),” “driving distance (km),” “driving time (minutes),” and “break intervals (minutes).” For detection of rapid acceleration and sudden braking, the collection unit applies rule-based processing to count events exceeding a threshold (e.g., ±2.5 m/s\hat{ }2) from the acceleration time series or pattern extraction using time-series clustering (e.g., DBSCAN). For understanding eco-driving tendencies, the collection unit combines fuel efficiency data with driving distance and speed profiles and calculates an “eco score” using machine learning models (e.g., LightGBM, random forest). For fatigue estimation, the collection unit inputs driving time, break frequency, and heart rate variability data into RNNs or time-series anomaly detection AI (e.g., LSTM Autoencoder) to output a “fatigue risk score.” Examples of output include “number of rapid accelerations: 5,” “number of sudden brakes: 3,” “eco-driving score: 0.85,” and “fatigue risk score: 0.30.” These analysis results are sent to subsequent prompt generation and generation units and used for generating individually optimized advice and warnings. As a technical effect, the collection unit, unlike conventional simple event recording or manual evaluation, integrates and analyzes high-dimensional time-series data from multiple sensors using AI and machine learning, enabling real-time and highly accurate estimation of complex driving characteristics such as driving style, eco-driving tendencies, and fatigue level. This reduces unnecessary warnings and misjudgments and provides optimized driving assistance, safety management, and fuel efficiency improvement advice for each driver. Application fields include personal assistants for individuals, commercial vehicle operation management and safety education, health management for long-distance trucks, driving evaluation for insurance companies, and analysis of driving tendencies for entire fleets. Furthermore, it can be applied to large-scale driving data analysis via cloud collaboration and promotion of safe driving in cooperation with urban traffic infrastructure.

The prompt generation unit can evaluate the driver's driving skill based on the collected information. For example, the prompt generation unit evaluates the frequency of rapid acceleration and sudden braking and scores the driver's driving skill. The prompt generation unit can also evaluate eco-driving skill based on the vehicle's driving distance and fuel efficiency data. Furthermore, the prompt generation unit can evaluate fatigue management skill based on the driver's driving time and frequency of breaks. Thus, the prompt generation unit can provide feedback tailored to the driver's driving skill. Specifically, the prompt generation unit receives driving event data (e.g., number of rapid accelerations, number of sudden brakes, driving distance, fuel efficiency, driving time, frequency of breaks, fatigue risk score, etc.) from the collection unit as input and inputs them to the driving skill evaluation module. The driving skill evaluation module performs rule-based evaluation (e.g., “excellent” if the number of rapid accelerations is less than 5), skill scoring using machine learning models (e.g., LightGBM), or comprehensive score calculation by weighted synthesis of multiple indicators (e.g., eco-driving 0.4, fatigue management 0.3, safe driving 0.3). Examples of input include “number of rapid accelerations: 3,” “number of sudden brakes: 2,” “fuel efficiency: 18 km/L,” “driving time: 120 minutes,” “2 breaks,” “fatigue risk: 0.2,” etc. The prompt generation unit calculates multiple evaluation indicators such as “safe driving score,” “eco-driving score,” “fatigue management skill score,” and outputs a comprehensive driving skill score (e.g., 0.92). Examples of output include “safe driving score: 0.95,” “eco-driving score: 0.88,” “fatigue management skill: 0.80,” “overall skill: 0.90,” etc. Based on these scores, the prompt generation unit automatically selects feedback generation templates (e.g., “Your safe driving is excellent,” “There is room for improvement in eco-driving”) and generates specific feedback sentences tailored to the driver's skill. Examples of input to the AI include skill evaluation score vector and past driving history, and examples of output include “This drive had a high safe driving score and good eco-driving. Please continue to drive safely.” The generated feedback is sent to the generation unit or provision unit and communicated to the driver via voice, display, or app notification. As a technical effect, the prompt generation unit, unlike conventional simple event notifications or manual evaluation, integrates and evaluates multiple driving indicators using AI and generates individually optimized skill feedback in real time. This promotes improvement in driving behavior, safety awareness, fuel efficiency, and fatigue management ability for drivers. Application fields include personal driving education, commercial vehicle driver evaluation, driving scoring for insurance companies, health management collaboration, and improvement of driving quality for entire fleets. Furthermore, it can be applied to large-scale skill evaluation via cloud collaboration and feedback to urban traffic policy.

The generation unit can propose training programs to improve the driver's driving skill. For example, the generation unit proposes driving techniques to reduce the frequency of rapid acceleration and sudden braking. The generation unit can also provide advice to improve eco-driving skill. Furthermore, the generation unit can propose timing and methods for breaks to improve fatigue management skill. Thus, the generation unit can provide specific advice to improve the driver's driving skill. Specifically, the generation unit receives driving skill evaluation scores and event history (e.g., number of rapid accelerations, eco-driving score, fatigue management skill, etc.) from the prompt generation unit as input and inputs them to the training program proposal module. The training program proposal module applies rule-based methods (e.g., if the number of rapid accelerations is high, “acceleration pedal operation training”), machine learning models (e.g., recommendation AI trained on past improvement history and skill improvement patterns), or personalized advice generation using large language models. Examples of input to the AI include “number of rapid accelerations: 7,” “eco-driving score: 0.65,” “fatigue management skill: 0.50,” etc. Based on these inputs, the generation unit proposes specific training items, methods, and timing, such as “practice acceleration pedal operation to reduce rapid acceleration,” “training for constant speed driving to improve eco-driving,” “recommend taking a break every 2 hours.” Examples of output include “Avoid rapid acceleration during your next drive and press the accelerator gently when starting,” “To improve eco-driving, focus on maintaining a constant speed,” “Take a 5-minute break every 2 hours during long drives,” etc. Furthermore, the generation unit automatically generates progress management and achievement evaluation for the training program (e.g., 30% reduction in rapid acceleration compared to the previous time) to support continuous skill improvement. The proposed training program is sent to the provision unit and communicated to the driver via voice, display, or app notification. As a technical effect, the generation unit, unlike conventional uniform advice or manual instruction, can automatically generate individually optimized, personalized training proposals in real time using AI. This enables efficient improvement of driving techniques, promotion of safe driving, fuel efficiency improvement, and enhancement of health management ability tailored to each driver's issues. Application fields include personal driving education, commercial vehicle driver training, risk reduction programs for insurance companies, health management collaboration, and improvement of driving quality for entire fleets. Furthermore, it can be applied to large-scale training program distribution via cloud collaboration and feedback to urban traffic safety policy.

The provision unit can introduce a reward system according to the driver's driving skill. For example, the provision unit provides fuel discount coupons to drivers with a low frequency of rapid acceleration and sudden braking. The provision unit can also award points to drivers with high eco-driving skill. Furthermore, the provision unit can provide discount coupons for rest facilities to drivers with high fatigue management skill. Thus, the provision unit can provide incentives to promote improvement of the driver's driving skill. Specifically, the provision unit receives driving skill evaluation scores (e.g., safe driving score, eco-driving score, fatigue management skill score, etc.) from the generation unit or prompt generation unit as input and inputs them to the reward system control module. The reward system control module applies rule-based methods (e.g., issue fuel discount coupon for safe driving score of 0.9 or higher), point awarding algorithms (e.g., eco-driving score×100 points), or incentive optimization using machine learning models (e.g., learning past reward history and behavioral changes to determine optimal reward content and timing). Examples of input to the AI include “safe driving score: 0.95,” “eco-driving score: 0.90,” “fatigue management skill: 0.85,” etc. Examples of output include “issue fuel discount coupon,” “award 100 eco points,” “issue rest facility discount coupon,” etc. Furthermore, the provision unit automatically optimizes the reward content, awarding timing, and notification means (e.g., app notification, email, in-vehicle display) according to the driver's usage trends and past reaction history. The issued rewards are managed via cloud collaboration and automatically awarded to the driver's account. As a technical effect, the provision unit, unlike conventional uniform rewards or manual incentive management, realizes an individually optimized, real-time reward system linked to AI-based driving skill evaluation. This strongly motivates improvement in driving behavior, promotion of safe driving, fuel efficiency, and enhancement of health management ability for drivers. Application fields include personal driving incentives, promotion of safe driving for commercial vehicles, risk reduction programs for insurance companies, health management collaboration, and improvement of driving quality for entire fleets. Furthermore, it can be applied to large-scale reward management via cloud collaboration and feedback to urban traffic safety policy.

The collection unit can monitor the driver's health status and provide health management advice. For example, the collection unit monitors the driver's heart rate and blood pressure and issues an alert when an abnormality is detected. The collection unit can also monitor the driver's sleep patterns and advise taking appropriate rest. Furthermore, the collection unit can monitor the driver's dietary and exercise habits and provide advice to promote a healthy lifestyle. Thus, the collection unit can support the driver's health management. Specifically, the collection unit acquires multidimensional data such as heart rate time series (e.g., 1-minute intervals×1440 points/day), blood pressure data (e.g., twice daily, morning and night), sleep patterns (e.g., deep sleep, light sleep, awake time), step count, calories burned, exercise time, and meal records (e.g., meal content and calorie intake via app collaboration) from biometric sensors installed in the vehicle (e.g., heart rate sensor, blood pressure sensor, skin temperature sensor, activity tracker, sleep tracker) and the driver's wearable devices. The collection unit preprocesses these data (e.g., noise removal, normalization, missing value imputation) and inputs them to a health status estimation AI (e.g., LSTM, LightGBM, anomaly detection Autoencoder). Examples of input to the AI include heart rate time series (1440 points), blood pressure values (2 points/day), sleep patterns (deep sleep 6 hours, light sleep 1 hour, awake 1 hour), step count (8000 steps), meal calories (1800 kcal), etc. The health status estimation AI outputs health labels such as “no abnormality,” “high stress,” “high blood pressure risk,” “sleep deprivation,” and risk scores (e.g., stress 0.7, sleep deprivation 0.8). When an abnormality is detected, the collection unit automatically generates advice such as “rest recommended during high stress,” “medical consultation recommended during high blood pressure risk,” “avoid long-distance driving during sleep deprivation.” Examples of output include “Current heart rate is within normal range,” “Sleep deprivation detected. Please take sufficient rest,” etc. The health advice is sent to the generation unit or provision unit and communicated to the driver via voice, display, or app notification. As a technical effect, the collection unit, unlike conventional manual health management or simple alert notifications, integrates and analyzes multiple biometric and lifestyle data using AI and provides individually optimized health management advice in real time. This enables efficient reduction of health risks, promotion of safe driving, and improvement of lifestyle habits for drivers. Application fields include personal health management, health monitoring for commercial vehicles, health risk management for long-distance trucks, health promotion programs for insurance companies, and health status analysis for entire fleets. Furthermore, it can be applied to large-scale health data analysis via cloud collaboration and collaboration with medical institutions.

The generation unit can estimate the driver's emotion and propose music or entertainment during driving based on the estimated emotion. For example, when the driver is feeling stressed, the generation unit proposes relaxing music. When the driver is relaxed, the generation unit can propose uplifting music. Furthermore, when the driver is bored, the generation unit can propose interesting podcasts or audiobooks. Thus, the generation unit can provide entertainment tailored to the driver's emotion. Specifically, the generation unit receives emotion estimation results (e.g., probability distribution vector such as stress 0.7, relaxation 0.2, boredom 0.1) from the collection unit or prompt generation unit as input and inputs them to the entertainment recommendation module. The entertainment recommendation module applies rule-based methods (e.g., if stress is 0.7 or higher, “relaxing music”), machine learning models (e.g., recommendation AI trained on past playback history and emotion change patterns), or personalized recommendation sentence generation using large language models. Examples of input to the AI include “emotion estimation vector (stress 0.8, relaxation 0.1, boredom 0.1),” “past music playback history,” “current driving situation,” etc. Based on these inputs, the generation unit automatically selects and proposes entertainment content tailored to the emotional state, driving situation, and past preferences, such as “relaxing classical music,” “uplifting up-tempo songs,” “interesting latest podcasts,” “audiobooks for long-distance driving.” Examples of output include “Playing relaxing music according to the current stress state,” “Proposing a new podcast as you seem to be bored,” etc. The proposed entertainment is sent to the provision unit and communicated to the driver via voice, display, or app notification. As a technical effect, the generation unit, unlike conventional uniform music playback or manual music selection, realizes individually optimized, real-time entertainment recommendation linked to AI-based emotion estimation. This enables efficient stress reduction, mood change, concentration maintenance, and improvement of driving experience for drivers. Application fields include personal assistants for individuals, long-distance driving support for commercial vehicles, health management collaboration, and improvement of comfort for entire fleets. Furthermore, it can be applied to large-scale preference analysis via cloud collaboration and collaboration with entertainment services.

The provision unit can estimate the driver's emotion and support communication during driving based on the estimated emotion. For example, when the driver is feeling stressed, the provision unit provides information in a calm tone. When the driver is relaxed, the provision unit can provide information in a friendly tone. Furthermore, when the driver is in a hurry, the provision unit can provide information quickly and concisely. Thus, the provision unit can support communication tailored to the driver's emotion during driving. Specifically, the provision unit receives emotion estimation results (e.g., probability distribution vector such as stress 0.85, relaxation 0.10, fatigue 0.05) from the collection unit or generation unit as input and inputs them to the communication control module. The communication control module automatically selects the optimal tone, speech rate, writing style, and emphasis words (e.g., “please rest assured,” “immediately”) for each emotion label and instructs output modules such as voice synthesis, display, and app notification. Examples of input to the AI include “emotion estimation vector (stress 0.9, relaxation 0.05, in a hurry 0.05),” “information category,” “output modality,” etc. Examples of output include “voice output of ‘Refueling available at point A, 2 km ahead’ in a calm tone,” “display of ‘Thank you for your hard work. 10 km to the destination’ in a friendly tone,” “voice output of ‘Right turn recommended’ in a short sentence when in a hurry,” etc. The generated communication instructions are sent to output modules such as voice synthesis, display control, and app notification, enabling information transmission optimized for the driver's emotional state. As a technical effect, the provision unit, unlike conventional uniform guidance or manual communication, realizes individually optimized, real-time communication control linked to AI-based emotion estimation. This enables efficient stress reduction, cognitive load reduction, improvement of driving experience, and promotion of safe driving for drivers. Application fields include personal assistants for individuals, fleet management for commercial vehicles, emergency vehicle support, health management collaboration, and improvement of comfort for entire fleets. Furthermore, it can be applied to large-scale emotion-adaptive communication via cloud collaboration and cooperation with urban traffic infrastructure.

The collection unit is capable of estimating the driver's emotion and providing advice to improve safety while driving based on the estimated emotion. For example, if the collection unit determines that the driver is feeling stressed, it can advise the driver to take a break. If the collection unit determines that the driver is relaxed, it can also provide advice to help maintain concentration. Furthermore, if the collection unit determines that the driver is fatigued, it can advise the driver to stop driving and take a rest. In this way, the collection unit can provide safe driving advice tailored to the driver's emotional state. Specifically, the collection unit preprocesses and extracts features from multimodal data (e.g., facial image tensors, voice waveforms, heart rate time series) obtained from in-vehicle cameras, microphones, biometric sensors, etc., and inputs them into an emotion estimation AI (e.g., CNN+RNN+fusion layer). Examples of AI input include facial images (224×224×3), voice spectrograms (128 dimensions×100 frames), and heart rate series (60 points). The emotion estimation AI outputs emotion labels such as “stress,” “relaxation,” and “fatigue,” as well as probability distributions (e.g., stress 0.8, relaxation 0.1, fatigue 0.1). Based on the emotion estimation results, the collection unit applies rule-based or machine learning-based advice generation algorithms in a safe driving advice generation module, such as “recommend a break during stress,” “advise maintaining concentration during relaxation,” and “recommend stopping driving during fatigue.” Example outputs include “Your current stress level is high, so we recommend taking a break,” “You are relaxed, but please maintain your concentration,” and “Fatigue has been detected, so please stop driving and take a rest.” As a subsequent process, the generated advice is sent to the prompt generation unit and the provision unit, and communicated to the driver via voice, display, or app notifications. As a technical effect, unlike conventional uniform safety advice or manual judgment, the collection unit enables individually optimized and real-time safe driving advice generation linked to AI-based emotion estimation. This allows for efficient promotion of safe driving, reduction of accident risk, and improvement of health management capabilities for drivers. Application fields include personal assistants for individuals, safe driving support for commercial vehicles, stress monitoring for emergency vehicles, health management integration, and overall fleet safety improvement. Furthermore, large-scale emotion state monitoring via cloud integration and collaboration with urban traffic infrastructure are also possible.

The generation unit is capable of estimating the driver's emotion and supporting stress management while driving based on the estimated emotion. For example, if the generation unit determines that the driver is feeling stressed, it can suggest deep breathing or relaxation techniques. If the generation unit determines that the driver is relaxed, it can also provide advice to prevent stress. Furthermore, if the generation unit determines that the driver is tense, it can suggest music or entertainment to help the driver relax. In this way, the generation unit can provide stress management support tailored to the driver's emotional state. Specifically, the generation unit receives emotion estimation results (e.g., probability distribution vectors such as stress 0.8, relaxation 0.1, tension 0.1) from the collection unit or the prompt generation unit as input and inputs them into a stress management support module. The generation unit applies rule-based methods (e.g., “if stress is 0.7 or higher, provide a deep breathing guide”), machine learning models (e.g., recommendation AI trained on past stress changes and intervention effects), or large language models for personalized advice generation as the stress management support module. Examples of AI input include “emotion estimation vector (stress 0.9, relaxation 0.05, tension 0.05),” “past stress management history,” and “current driving situation.” Based on these input values, the generation unit automatically generates stress management support such as “deep breathing guide,” “relaxation music playback,” “stress prevention advice,” and “entertainment suggestions for tension relief,” according to the emotional state, driving situation, and past intervention effects. Example outputs include “Your stress level is high, so please take a deep breath,” “To maintain your relaxed state, take frequent breaks,” and “Tension has been detected, so relaxation music will be played.” As a subsequent process, the generated stress management support is sent to the provision unit and communicated to the driver via voice, display, or app notifications. As a technical effect, unlike conventional uniform stress countermeasures or manual interventions, the generation unit enables individually optimized and real-time stress management support linked to AI-based emotion estimation. This allows for efficient stress reduction, improvement of health management capabilities, and promotion of safe driving for drivers. Application fields include personal assistants for individuals, health management for commercial vehicles, stress care for long-distance trucks, health management integration, and overall fleet comfort improvement. Furthermore, large-scale stress management support via cloud integration and collaboration with medical institutions are also possible.

The provision unit is capable of estimating the driver's emotion and supporting mood change while driving based on the estimated emotion. For example, if the provision unit determines that the driver is feeling stressed, it can suggest a short break for mood change. If the provision unit determines that the driver is relaxed, it can also suggest activities to boost the driver's mood. Furthermore, if the provision unit determines that the driver is bored, it can suggest new routes or sightseeing spots. In this way, the provision unit can provide mood change support tailored to the driver's emotional state. Specifically, the provision unit receives emotion estimation results (e.g., probability distribution vectors such as stress 0.7, relaxation 0.2, boredom 0.1) from the collection unit or the generation unit as input and inputs them into a mood change support module. The provision unit automatically selects optimal mood change activities for each emotion label (e.g., “break suggestion” during stress, “drive game suggestion” during relaxation, “new route or sightseeing spot suggestion” during boredom) and instructs output modules such as voice synthesis, display, or app notifications. Examples of AI input include “emotion estimation vector (stress 0.8, relaxation 0.1, boredom 0.1),” “current location,” “driving route,” and “past mood change history.” Example outputs include “Your stress level is high, so please take a break at the next service area,” “You are relaxed, would you like to enjoy a driving game?” and “You seem to be bored, so we suggest a new sightseeing spot.” As a subsequent process, the generated mood change support is communicated to the driver via voice, display, or app notifications. As a technical effect, unlike conventional uniform mood change suggestions or manual interventions, the provision unit enables individually optimized and real-time mood change support linked to AI-based emotion estimation. This allows for efficient stress reduction, mood change, improvement of driving experience, and promotion of safe driving for drivers. Application fields include personal assistants for individuals, long-distance driving support for commercial vehicles, optimization of guidance for sightseeing buses, health management integration, and overall fleet comfort improvement. Furthermore, large-scale mood change support via cloud integration and collaboration with urban traffic infrastructure are also possible.

Below is a brief explanation of the processing flow of Example of the Embodiment. Specifically, in this system, the collection unit collects multidimensional structured data (e.g., position coordinates [latitude and longitude], speed values [km/h], remaining fuel amount [liters], engine temperature [° C.], OBD-II codes, traffic flow data, weather codes from weather APIs, etc.] obtained from various vehicle sensors such as GPS receivers, speed sensors, fuel sensors, engine diagnostic modules, and external communication modules) as time-series tensors or structured data in JSON format. The collection unit acquires these data every second or upon event triggers, and if there are missing or abnormal values, applies statistical imputation algorithms (e.g., linear interpolation, median imputation) or outlier removal filters (e.g., Z-score judgment) to ensure data quality. The prompt generation unit uses template-based sentence generation engines or rule-based mapping tables to automatically convert the collected structured data into natural language text. For example, position information (latitude 35.6895, longitude 139.6917) is converted to “The current position is 35.6895,139.6917”, speed 60 to “The current speed is 60 km/h”, and remaining fuel amount 12 to “The remaining fuel amount is 12 liters”. The prompt generation unit selects different templates and levels of detail for each information category (e.g., navigation, vehicle status, weather, traffic), and automatically adjusts sentence length and expression according to importance and the driver's state (e.g., estimated stress value). The generation unit inputs the natural language text received from the prompt generation unit into a large language model with a Transformer architecture of several billion parameters. Examples of input include “The current position is 35.6895,139.6917. The remaining fuel amount is 12 liters. Please tell me the nearest gas station.” and “The current speed is 60 km/h. Should I turn right at the next intersection?” The generation unit tokenizes the input text, performs sequence transformation with encoder and decoder layers, and generates natural language text as output (e.g., “The nearest gas station is at point A, 2 km ahead”, “Right turn is not recommended. There is a traffic jam near the intersection”). The generation unit attaches a confidence score (e.g., 0.92) and option labels to the output, and only sends the output to the provision unit if the confidence exceeds a certain threshold in the subsequent threshold judgment unit. The provision unit provides information to the driver via a voice synthesis module (e.g., WaveNet-based TTS) or an in-vehicle display control module. Examples of voice output include “There is a gas station at point A, 2 km ahead”, and examples of display output include “Right turn is not recommended. There is a traffic jam.” As a technical effect, unlike conventional human information search or simple rule-based responses, this system integrates multiple real-time sensor data and performs sequence analysis and semantic understanding in high-dimensional space, greatly improving the accuracy and immediacy of responses. This dramatically enhances the safety and convenience of driving support systems, contributing to reduced driver burden and accident prevention. Application fields include personal assistants for general passenger vehicles, operation management for commercial vehicles, navigation support for emergency vehicles, and driving assistance for disabled persons. Furthermore, cloud-linked fleet management and realization of smart cities through collaboration with urban traffic infrastructure are also possible.
Step 1: The collection unit collects information acquired from the vehicle. The information acquired from the vehicle includes position information of the vehicle, speed, remaining fuel amount, engine status, surrounding traffic conditions, and weather information. The collection unit acquires position information using GPS and acquires speed and remaining fuel amount using internal sensors. Furthermore, engine status, surrounding traffic conditions, and weather information can be acquired using communication functions. Step 2: The prompt generation unit converts the information collected by the collection unit into prompts. Prompt generation refers to converting the collected information into a format that is easily understood by the generation AI. For example, position information is converted to “The current position is XX”, speed to “The current speed is XX km/h”, and remaining fuel amount to “The remaining fuel amount is XX liters”. Step 3: The generation unit generates a response based on the information converted into prompts by the prompt generation unit. For example, the generation unit generates an appropriate response to a driver's question. If the driver asks “Please tell me the nearest gas station”, the generation unit proposes the optimal gas station based on the vehicle's position information and remaining fuel amount. If the driver asks “Should I turn right at the next intersection?”, the generation unit provides appropriate advice based on surrounding traffic conditions and weather information. Step 4: The provision unit provides the response generated by the generation unit to the driver. For example, the generated response is provided to the driver via voice or display. This allows the driver to obtain accurate information in real time. Specifically, in Step 1, the collection unit collects multidimensional structured data (e.g., position coordinates [latitude and longitude], speed values [km/h], remaining fuel amount [liters], engine temperature [° C.], OBD-II codes, traffic flow data, weather codes from weather APIs, etc.] obtained from various vehicle sensors such as GPS receivers, speed sensors, fuel sensors, engine diagnostic modules, and external communication modules as time-series tensors or structured data in JSON format. The collection unit acquires these data every second or upon event triggers, and if there are missing or abnormal values, applies statistical imputation algorithms (e.g., linear interpolation, median imputation) or outlier removal filters (e.g., Z-score judgment) to ensure data quality. In Step 2, the prompt generation unit uses template-based sentence generation engines or rule-based mapping tables to automatically convert the collected structured data into natural language text. For example, position information (latitude 35.6895, longitude 139.6917) is converted to “The current position is 35.6895,139.6917”, speed 60 to “The current speed is 60 km/h”, and remaining fuel amount 12 to “The remaining fuel amount is 12 liters”. The prompt generation unit selects different templates and levels of detail for each information category (e.g., navigation, vehicle status, weather, traffic), and automatically adjusts sentence length and expression according to importance and the driver's state (e.g., estimated stress value). In Step 3, the generation unit inputs the natural language text received from the prompt generation unit into a large language model with a Transformer architecture of several billion parameters. Examples of input include “The current position is 35.6895,139.6917. The remaining fuel amount is 12 liters. Please tell me the nearest gas station.” and “The current speed is 60 km/h. Should I turn right at the next intersection?” The generation unit tokenizes the input text, performs sequence transformation with encoder and decoder layers, and generates natural language text as output (e.g., “The nearest gas station is at point A, 2 km ahead”, “Right turn is not recommended. There is a traffic jam near the intersection”). The generation unit attaches a confidence score (e.g., 0.92) and option labels to the output, and only sends the output to the provision unit if the confidence exceeds a certain threshold in the subsequent threshold judgment unit. In Step 4, the provision unit provides information to the driver via a voice synthesis module (e.g., WaveNet-based TTS) or an in-vehicle display control module. Examples of voice output include “There is a gas station at point A, 2 km ahead”, and examples of display output include “Right turn is not recommended. There is a traffic jam.” As a technical effect, unlike conventional human information search or simple rule-based responses, this system integrates multiple real-time sensor data and performs sequence analysis and semantic understanding in high-dimensional space, greatly improving the accuracy and immediacy of responses. This dramatically enhances the safety and convenience of driving support systems, contributing to reduced driver burden and accident prevention. Application fields include personal assistants for general passenger vehicles, operation management for commercial vehicles, navigation support for emergency vehicles, and driving assistance for disabled persons. Furthermore, cloud-linked fleet management and realization of smart cities through collaboration with urban traffic infrastructure are also possible.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the above-described collection unit, prompt generation unit, generation unit, and provision unit is implemented by at least one of, for example, a smart device 14 and a data processing apparatus 12. For example, the collection unit acquires vehicle position information, speed, remaining fuel amount, and the like using a camera 42 or communication I/F 44 of the smart device 14. The prompt generation unit converts the information collected by the control unit 46A of the smart device 14 into prompts. The generation unit generates a response based on the information converted into prompts by a specific processing unit 290 of the data processing apparatus 12. The provision unit provides the generated response to the driver using an output device 40 of the smart device 14. The correspondence between each unit and the device or control unit is not limited to the above examples and various modifications are possible.

### Second Embodiment

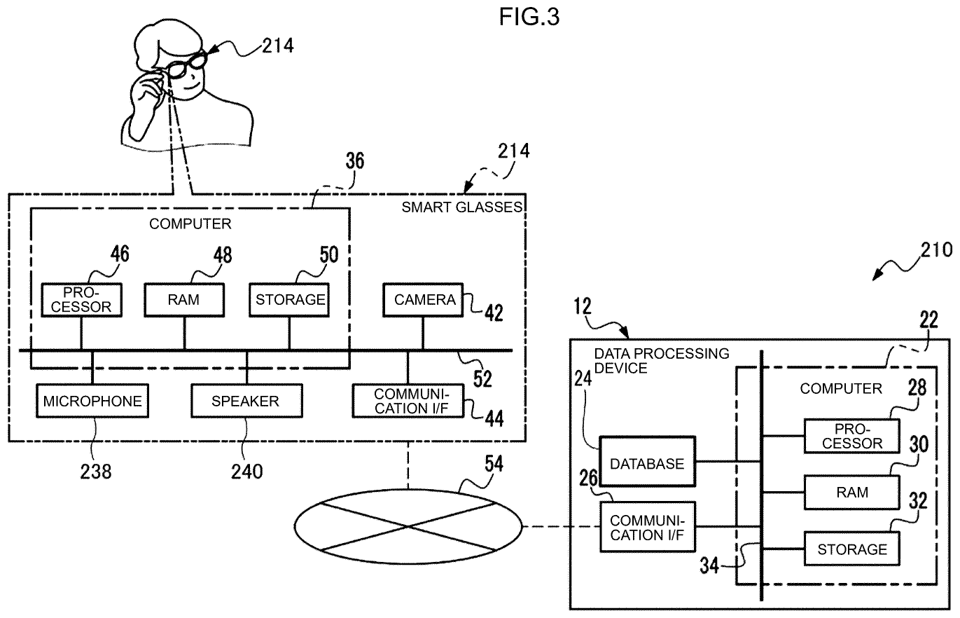

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

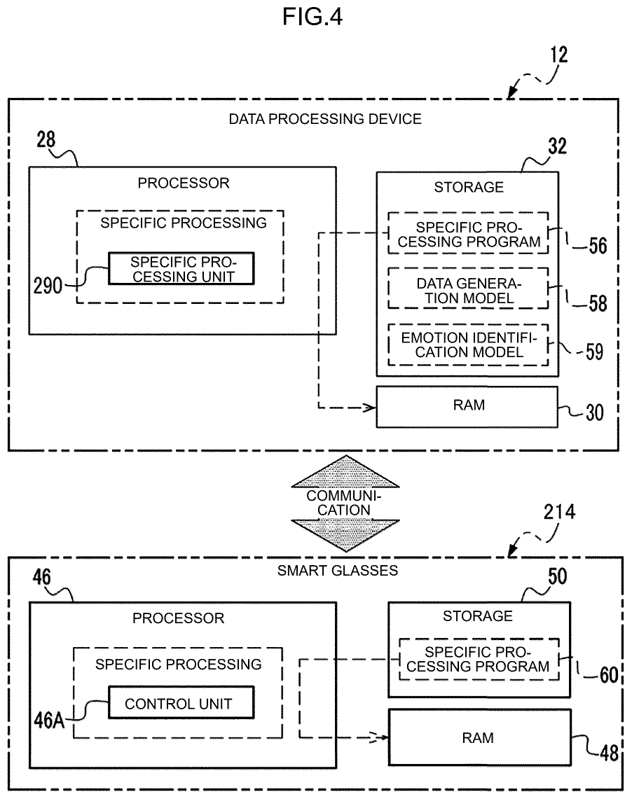

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the above-described collection unit, prompt generation unit, generation unit, and provision unit is implemented by at least one of, for example, smart glasses 214 and a data processing apparatus 12. For example, the collection unit acquires vehicle position information, speed, remaining fuel amount, and the like using a camera 42 or communication I/F 44 of the smart glasses 214. The prompt generation unit converts the information collected by the control unit 46A of the smart glasses 214 into prompts. The generation unit generates a response based on the information converted into prompts by a specific processing unit 290 of the data processing apparatus 12. The provision unit provides the generated response to the driver using a speaker 240 of the smart glasses 214. The correspondence between each unit and the device or control unit is not limited to the above examples and various modifications are possible.

### Third Embodiment

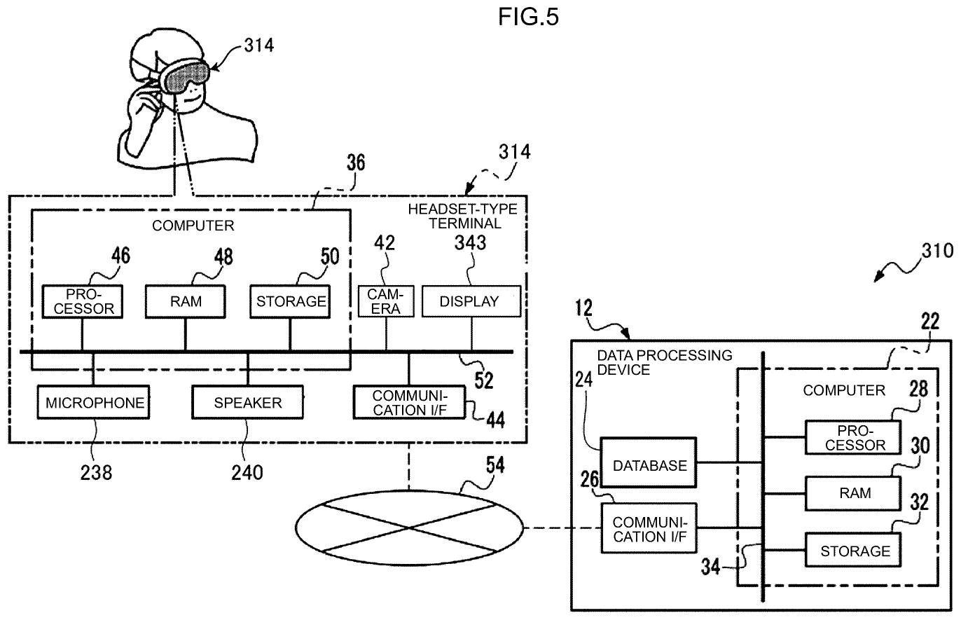

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

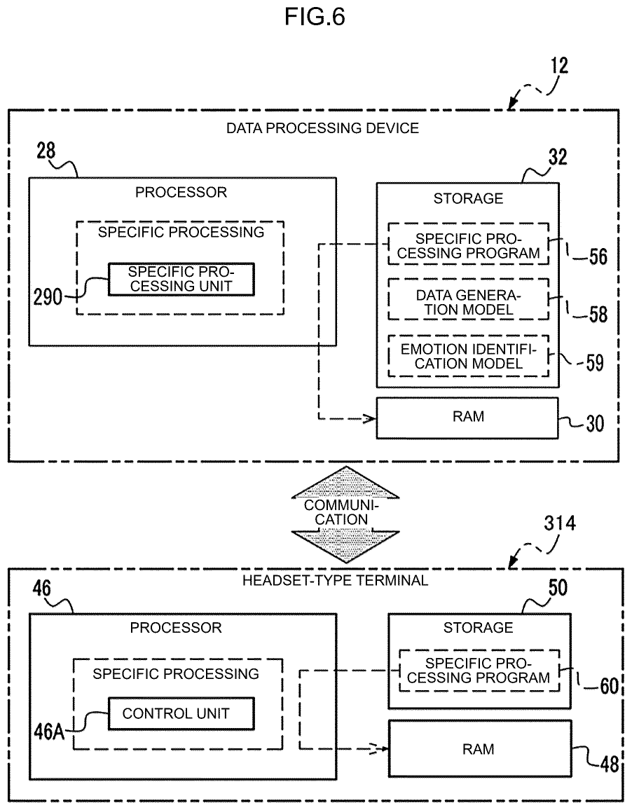

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the above-described collection unit, prompt generation unit, generation unit, and provision unit is implemented by at least one of, for example, a headset-type terminal 314 and a data processing apparatus 12. For example, the collection unit acquires vehicle position information, speed, remaining fuel amount, and the like using a camera 42 or communication I/F 44 of the headset-type terminal 314. The prompt generation unit converts the information collected by the control unit 46A of the headset-type terminal 314 into prompts. The generation unit generates a response based on the information converted into prompts by a specific processing unit 290 of the data processing apparatus 12. The provision unit provides the generated response to the driver using a speaker 240 of the headset-type terminal 314. The correspondence between each unit and the device or control unit is not limited to the above examples and various modifications are possible.

### Fourth Embodiment

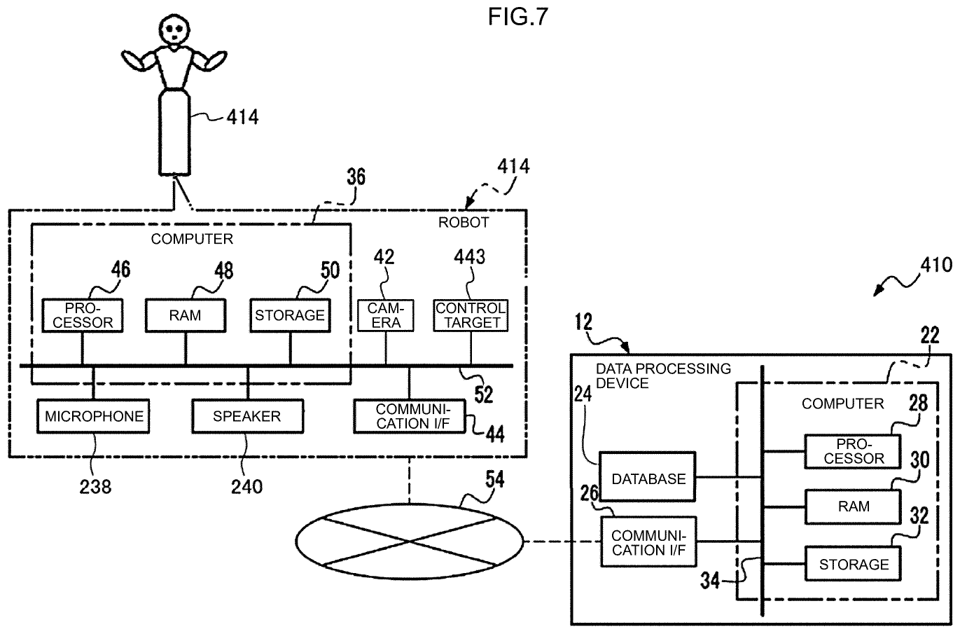

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

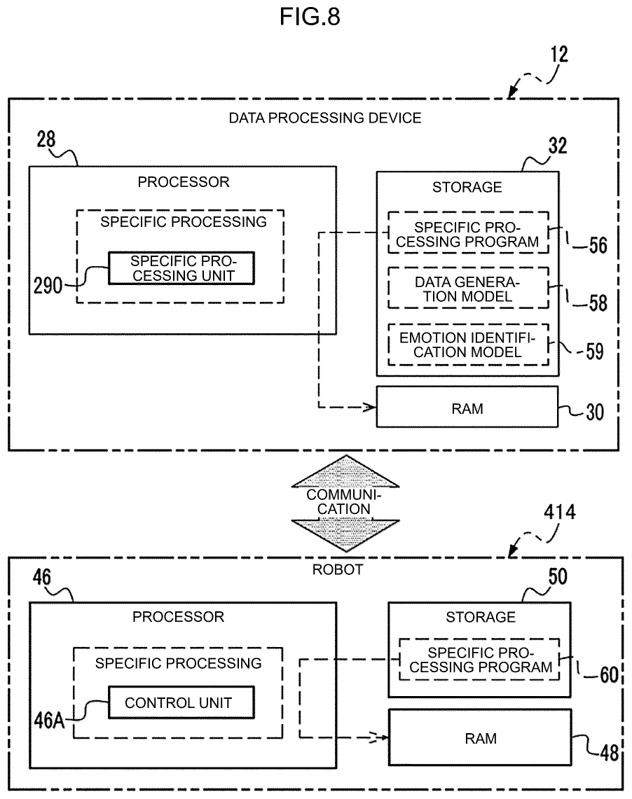

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the above-described collection unit, prompt generation unit, generation unit, and provision unit is implemented by at least one of, for example, a robot 414 and a data processing apparatus 12. For example, the collection unit acquires vehicle position information, speed, remaining fuel amount, and the like using a camera 42 or communication I/F 44 of the robot 414. The prompt generation unit converts the information collected by the control unit 46A of the robot 414 into prompts. The generation unit generates a response based on the information converted into prompts by a specific processing unit 290 of the data processing apparatus 12. The provision unit provides the generated response to the driver using a speaker 240 of the robot 414. The correspondence between each unit and the device or control unit is not limited to the above examples and various modifications are possible.

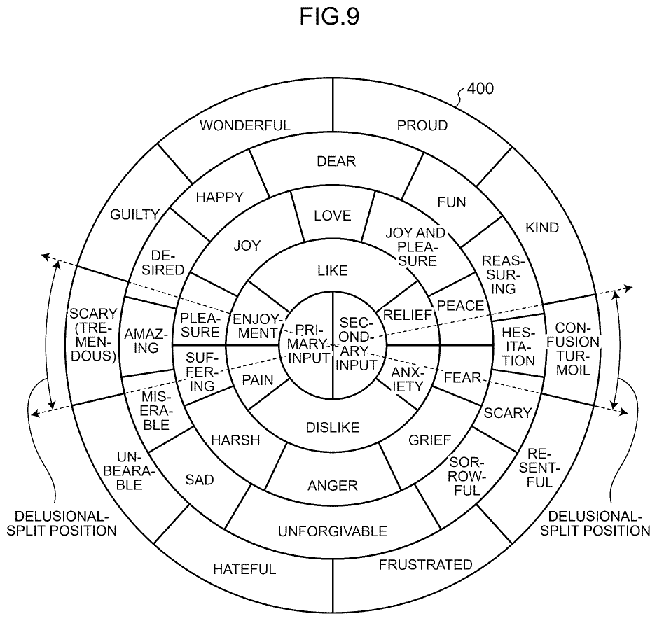

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

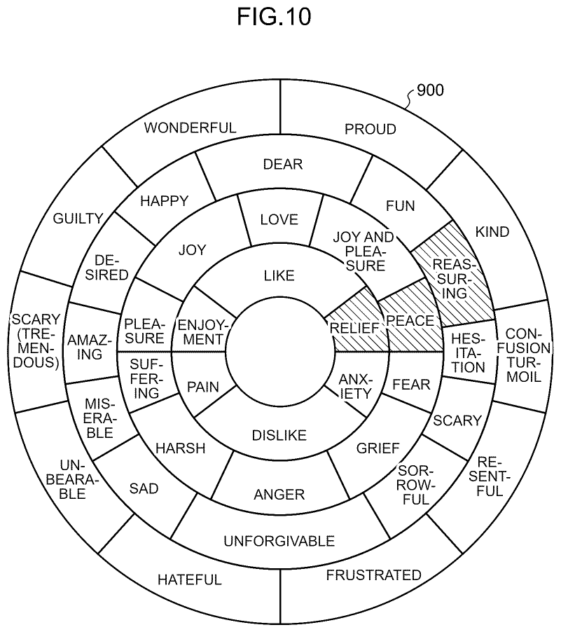

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1)A system comprising: a collection unit configured to collect information acquired from a vehicle; a prompt generation unit configured to convert the information collected by the collection unit into prompts; a generation unit configured to generate a response based on the information converted into prompts by the prompt generation unit; and a provision unit configured to provide the response generated by the generation unit to a driver.
(Supplementary Note 2)The system according to Supplementary Note 1, wherein the collection unit is configured to collect position information of the vehicle, speed, remaining fuel amount, engine status, surrounding traffic conditions, and weather information.
(Supplementary Note 3)The system according to Supplementary Note 1, wherein the prompt generation unit is configured to convert the collected information into formats such as “The current position is XX”, “The current speed is XX km/h”, and “The remaining fuel amount is XX liters”.
(Supplementary Note 4)The system according to Supplementary Note 1, wherein the generation unit is configured to generate an appropriate response to a driver's question based on the information converted into prompts.
(Supplementary Note 5)The system according to Supplementary Note 1, wherein the provision unit is configured to provide the generated response to the driver via voice or display.
(Supplementary Note 6)The system according to Supplementary Note 1, wherein the provision unit is configured to provide information required by the driver while driving or information useful for supporting driving.
(Supplementary Note 7)The system according to Supplementary Note 1, wherein the collection unit is configured to estimate the driver's emotion and adjust the timing of information collection based on the estimated emotion of the driver.
(Supplementary Note 8)The system according to Supplementary Note 1, wherein the collection unit is configured to analyze past driving history and select an appropriate information collection method.
(Supplementary Note 9)The system according to Supplementary Note 1, wherein the collection unit is configured to perform filtering during information collection based on the driver's current driving situation or area of interest.
(Supplementary Note 10)The system according to Supplementary Note 1, wherein the collection unit is configured to estimate the driver's emotion and determine the priority of information to be collected based on the estimated emotion of the driver.
(Supplementary Note 11)The system according to Supplementary Note 1, wherein the collection unit is configured to preferentially collect highly relevant information during information collection based on the driver's geographic position information.
(Supplementary Note 12)The system according to Supplementary Note 1, wherein the collection unit is configured to analyze the driver's social media activity during information collection and collect relevant information.
(Supplementary Note 13)The system according to Supplementary Note 1, wherein the prompt generation unit is configured to estimate the driver's emotion and adjust the expression method of prompts based on the estimated emotion of the driver.
(Supplementary Note 14)The system according to Supplementary Note 1, wherein the prompt generation unit is configured to adjust the level of detail of prompts based on the importance of the information.
(Supplementary Note 15)The system according to Supplementary Note 1, wherein the prompt generation unit is configured to apply different prompt generation algorithms according to the category of information.
(Supplementary Note 16)The system according to Supplementary Note 1, wherein the prompt generation unit is configured to estimate the driver's emotion and adjust the length of prompts based on the estimated emotion of the driver.
(Supplementary Note 17)The system according to Supplementary Note 1, wherein the prompt generation unit is configured to determine the priority of prompts based on the timing of information collection.
(Supplementary Note 18)The system according to Supplementary Note 1, wherein the prompt generation unit is configured to adjust the order of prompts based on the relevance of the information.
(Supplementary Note 19)The system according to Supplementary Note 1, wherein the generation unit is configured to estimate the driver's emotion and adjust the expression method of responses based on the estimated emotion of the driver.
(Supplementary Note 20)The system according to Supplementary Note 1, wherein the generation unit is configured to adjust the level of detail of responses during response generation based on the importance of the information.
(Supplementary Note 21)The system according to Supplementary Note 1, wherein the generation unit is configured to apply different generation algorithms during response generation according to the category of information.
(Supplementary Note 22)The system according to Supplementary Note 1, wherein the generation unit is configured to estimate the driver's emotion and adjust the length of responses based on the estimated emotion of the driver.
(Supplementary Note 23)The system according to Supplementary Note 1, wherein the generation unit is configured to determine the priority of responses during response generation based on the timing of information collection.
(Supplementary Note 24)The system according to Supplementary Note 1, wherein the generation unit is configured to adjust the order of responses during response generation based on the relevance of the information.
(Supplementary Note 25)The system according to Supplementary Note 1, wherein the provision unit is configured to estimate the driver's emotion and adjust the method of providing information based on the estimated emotion of the driver.
(Supplementary Note 26)The system according to Supplementary Note 1, wherein the provision unit is configured to refer to the driver's past driving history during information provision and select an appropriate provision method.
(Supplementary Note 27)The system according to Supplementary Note 1, wherein the provision unit is configured to customize the means of provision during information provision based on the driver's current driving situation.
(Supplementary Note 28)The system according to Supplementary Note 1, wherein the provision unit is configured to estimate the driver's emotion and determine the priority of information provision based on the estimated emotion of the driver.
(Supplementary Note 29)The system according to Supplementary Note 1, wherein the provision unit is configured to select an appropriate provision method during information provision based on the driver's geographic position information.
(Supplementary Note 30)The system according to Supplementary Note 1, wherein the provision unit is configured to analyze the driver's social media activity during information provision and propose means of provision.

What is claimed is:

1. A system comprising:
a communication interface configured to communicate with a client terminal and an external data source via a packet-switched network;
a memory storing a data generation model comprising a Transformer architecture obtained by deep learning on a neural network, and an emotion identification model; and
circuitry configured to:
receive, from the external data source via the communication interface and the packet-switched network, structured data comprising at least one of position data, speed data, status data, or environmental data;
convert the structured data into a natural language prompt by applying a template-based sentence generation algorithm to map the structured data to text;
tokenize the natural language prompt and input the tokenized prompt into the data generation model to generate response data;
estimate an emotion of a user by applying the emotion identification model to sensor data received from the client terminal via the communication interface; and
transmit the response data to the client terminal via the communication interface and the packet-switched network, the response data causing the client terminal to output the response data to the user.

2. The system according to claim 1, wherein the structured data comprises vehicle data acquired from a vehicle, the vehicle data comprising at least one of position information acquired from a GPS receiver, speed acquired from a speed sensor, remaining fuel amount acquired from a fuel sensor, engine status acquired from an engine diagnostic module, surrounding traffic conditions acquired from a communication module, or weather information acquired from a weather API.

3. The system according to claim 1, wherein the circuitry is further configured to apply a statistical imputation algorithm or an outlier removal filter to the structured data when missing data or abnormal values are detected in the structured data.

4. The system according to claim 1, wherein the template-based sentence generation algorithm is configured to select different templates and levels of detail for each information category of the structured data, and to automatically adjust sentence length and expression according to an importance score.

5. The system according to claim 1, wherein the circuitry is further configured to attach a confidence score to the response data and to transmit the response data to the client terminal only when the confidence score exceeds a threshold.

6. The system according to claim 1, wherein the circuitry is further configured to adjust a timing of receiving the structured data from the external data source based on the estimated emotion, such that when the estimated emotion indicates stress, the circuitry reduces a frequency of receiving the structured data, and when the estimated emotion indicates relaxation, the circuitry increases the frequency.

7. The system according to claim 1, wherein the circuitry is further configured to analyze a past history stored in a database associated with the user to select an optimal data collection method using at least one of a decision tree, a random forest, or a reinforcement learning model.

8. The system according to claim 1, wherein the circuitry is further configured to perform filtering during data collection based on a current situation or an area of interest of the user, the filtering comprising applying a relevance scoring algorithm using at least one of a rule-based method, a Bayesian network, or a machine learning model.

9. The system according to claim 1, wherein the circuitry is further configured to determine a priority of the structured data to be received based on the estimated emotion, such that when the estimated emotion indicates stress, the circuitry prioritizes safety or warning information, and when the estimated emotion indicates relaxation, the circuitry receives detailed information.

10. The system according to claim 1, wherein the circuitry is further configured to preferentially receive structured data associated with a geographic region corresponding to geographic position information received from the client terminal via the communication interface.

11. The system according to claim 1, wherein the circuitry is further configured to receive social media activity data from the client terminal, extract topics of interest from the social media activity data using a natural language processing model, and adjust a type of the structured data to be received based on the extracted topics of interest.

12. The system according to claim 1, wherein the circuitry is further configured to adjust an expression method of the natural language prompt based on the estimated emotion, such that when the estimated emotion indicates stress, the circuitry generates a concise prompt, and when the estimated emotion indicates relaxation, the circuitry generates a detailed prompt.

13. The system according to claim 1, wherein the circuitry is further configured to adjust a level of detail of the natural language prompt based on an importance score associated with the structured data, such that for structured data having a high importance score, the circuitry generates a detailed prompt, and for structured data having a low importance score, the circuitry generates a concise prompt.

14. The system according to claim 1, wherein the circuitry is further configured to apply different prompt generation algorithms according to a category of the structured data.

15. The system according to claim 1, wherein the circuitry is further configured to adjust a length of the response data based on the estimated emotion, such that when the estimated emotion indicates stress, the circuitry generates a short response, and when the estimated emotion indicates relaxation, the circuitry generates a detailed response.

16. The system according to claim 1, wherein the circuitry is further configured to determine a priority of the response data based on a timing of data collection, such that response data based on more recently collected structured data is transmitted with a higher priority.

17. The system according to claim 1, wherein the circuitry is further configured to adjust an order of information in the response data based on a relevance score, such that highly relevant information is presented first.

18. A system comprising:
a communication interface configured to communicate, via a packet-switched network conforming to at least one of a 5G, Wi-Fi, or Bluetooth communication standard, with a client terminal comprising a touch panel, a microphone, a speaker, a camera having a CMOS image sensor, and a display, and with an external data source;
a processor;
a random-access memory;
a memory storing a data generation model comprising a Transformer architecture obtained by deep learning on a neural network, and an emotion identification model; and
circuitry configured to:
receive, from the external data source via the communication interface and the packet-switched network, structured data comprising at least one of position data, speed data, status data, or environmental data;
convert the structured data into a natural language prompt by applying a template-based sentence generation algorithm;
tokenize the natural language prompt and input the tokenized prompt into the data generation model to generate response data;
estimate an emotion of a user by applying the emotion identification model to at least one of voice data captured by the microphone or image data captured by the camera of the client terminal, received via the communication interface;
adjust at least one of a length, a level of detail, or an expression style of the response data based on the estimated emotion; and
transmit the response data to the client terminal via the communication interface and the packet-switched network, the response data causing the client terminal to output the response data to the user via at least one of the display or the speaker.

19. The system according to claim 18, wherein the data generation model comprises at least one of a text generation AI, an image generation AI, or a multimodal generation AI, and wherein the data generation model is a fine-tuned model configured to output inference results from prompts without instructions.

20. A method performed by circuitry of a system comprising a communication interface, a memory storing a data generation model comprising a Transformer architecture obtained by deep learning on a neural network and an emotion identification model, the method comprising:
receiving, from an external data source via the communication interface and a packet-switched network, structured data comprising at least one of position data, speed data, status data, or environmental data;
converting the structured data into a natural language prompt by applying a template-based sentence generation algorithm to map the structured data to text;
tokenizing the natural language prompt and inputting the tokenized prompt into the data generation model to generate response data;
estimating an emotion of a user by applying the emotion identification model to sensor data received from a client terminal via the communication interface; and
transmitting the response data to the client terminal via the communication interface and the packet-switched network, the response data causing the client terminal to output the response data to the user.
